(19) United States
(12) Patent Application Publication
(10) Pub. No.: US 2025/0023614 A1
(43) Pub. Date: Jan. 16, 2025

(54) BASE STATION INFORMATION EXCHANGE WITH QOS CLASS AND/OR MEASUREMENT METRICS

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/352,879

(22) Filed: Jul. 14, 2023

(51) Int. Cl. H04B 7/06; H04B 17/345; H04L 5/00; H04W 72/56

(52) U.S. Cl. CPC H04B 7/0632; H04B 7/0695; H04B 17/345; H04L 5/0053; H04W 72/56

(57) ABSTRACT

A first network node measures cross link interference (CLI) from a transmission of a second network node for a set of one or more candidate beam pairs, each candidate beam pair of the set of one or more candidate beam pairs including an uplink beam of the first network node and a downlink beam of the second network node. The first network node provides CLI information indicating at least one of one or more preferred beam pairs or one or more non-preferred beam pairs based on a CLI measurement from the transmission, the CLI information further indicating at least a first Quality of Service (QoS) or a first priority level for uplink traffic of the first network node.

### INTRODUCTION

The present disclosure relates generally to communication systems, and more particularly, to wireless communication employing inter-base station cross link interference mitigation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a first network node is provided. The method includes measuring cross link interference (CLI) from a transmission of a second network node for a set of one or more candidate beam pairs, each candidate beam pair of the set of one or more candidate beam pairs including an uplink beam of the first network node and a downlink beam of the second network node; and providing CLI information indicating at least one of one or more preferred beam pairs or one or more non-preferred beam pairs based on a CLI measurement from the transmission, the CLI information further indicating at least a first Quality of Service (QoS) or a first priority level for uplink traffic of the first network node.

In an aspect of the disclosure, an apparatus for wireless communication at a first network node is provided. The apparatus includes means for measuring CLI from a transmission of a second network node for a set of one or more candidate beam pairs, each candidate beam pair of the set of one or more candidate beam pairs including an uplink beam of the first network node and a downlink beam of the second network node; and means for providing CLI information indicating at least one of one or more preferred beam pairs or one or more non-preferred beam pairs based on a CLI measurement from the transmission, the CLI information further indicating at least a first QoS or a first priority level for uplink traffic of the first network node.

In an aspect of the disclosure, an apparatus for wireless communication at a first network node is provided. The apparatus includes one or more memories and one or more processors coupled to the one or more memories and, based at least in part on information stored in the one or more memories, the one or more processors, individually or in any combination, are configured to cause the first network node to measure CLI from a transmission of a second network node for a set of one or more candidate beam pairs, each candidate beam pair of the set of one or more candidate beam pairs including an uplink beam of the first network node and a downlink beam of the second network node; and provide CLI information indicating at least one of one or more preferred beam pairs or one or more non-preferred beam pairs based on a CLI measurement from the transmission, the CLI information further indicating at least a first QoS or a first priority level for uplink traffic of the first network node.

In an aspect of the disclosure, a computer-readable storage medium is provided. The computer-readable storage medium stores computer executable code at a first network node, the code when executed by one or more processors causes the first network node to: measure CLI from a transmission of a second network node for a set of one or more candidate beam pairs, each candidate beam pair of the set of one or more candidate beam pairs including an uplink beam of the first network node and a downlink beam of the second network node; and provide CLI information indicating at least one of one or more preferred beam pairs or one or more non-preferred beam pairs based on a CLI measurement from the transmission, the CLI information further indicating at least a first QoS or a first priority level for uplink traffic of the first network node.

In an aspect of the disclosure, a method of wireless communication at a second network node is provided. The method includes obtaining CLI information of a first network node, the CLI information indicating at least one of one or more preferred beam pairs or one or more non-preferred beam pairs, the CLI information further indicating at least a first QoS or a first priority level for uplink traffic of the first network node; and adjusting downlink communication based on a CLI reduction mechanism in response to the first QoS or the first priority level of the uplink traffic of the first network node being higher than or equal to a second QoS or a second priority level of downlink traffic of the second network node, or providing a response to the first network node in response to the first QoS or the first priority level of the uplink traffic of the first network node being less than the second QoS or the second priority level of the downlink traffic of the second network node.

In an aspect of the disclosure, an apparatus for wireless communication at a second network node is provided. The apparatus includes means for obtaining CLI information of a first network node, the CLI information indicating at least one of one or more preferred beam pairs or one or more non-preferred beam pairs, the CLI information further indicating at least a first QoS or a first priority level for uplink traffic of the first network node; and means for adjusting downlink communication based on a CLI reduction mechanism in response to the first QoS or the first priority level of the uplink traffic of the first network node being higher than or equal to a second QoS or a second priority level of downlink traffic of the second network node, or means for providing a response to the first network node in response to the first QoS or the first priority level of the uplink traffic of the first network node being less than the second QoS or the second priority level of the downlink traffic of the second network node.

In an aspect of the disclosure, an apparatus for wireless communication at a second network node is provided. The apparatus includes one or more memories and one or more processors coupled to the one or more memories and, based at least in part on information stored in the one or more memories, the one or more processors, individually or in any combination, are configured to cause the second network node to obtain CLI information of a first network node, the CLI information indicating at least one of one or more preferred beam pairs or one or more non-preferred beam pairs, the CLI information further indicating at least a first QoS or a first priority level for uplink traffic of the first network node; and adjust downlink communication based on a CLI reduction mechanism in response to the first QoS or the first priority level of the uplink traffic of the first network node being higher than or equal to a second QoS or a second priority level of downlink traffic of the second network node, or provide a response to the first network node in response to the first QoS or the first priority level of the uplink traffic of the first network node being less than the second QoS or the second priority level of the downlink traffic of the second network node.

In an aspect of the disclosure, a computer-readable storage medium is provided. The computer-readable storage medium stores computer executable code at a second network node, the code when executed by one or more processors causes the first second node to: obtain CLI information of a first network node, the CLI information indicating at least one of one or more preferred beam pairs or one or more non-preferred beam pairs, the CLI information further indicating at least a first QoS or a first priority level for uplink traffic of the first network node; and adjust downlink communication based on a CLI reduction mechanism in response to the first QoS or the first priority level of the uplink traffic of the first network node being higher than or equal to a second QoS or a second priority level of downlink traffic of the second network node, or provide a response to the first network node in response to the first QoS or the first priority level of the uplink traffic of the first network node being less than the second QoS or the second priority level of the downlink traffic of the second network node.

In an aspect of the disclosure, a method of wireless communication at a first network node is provided. The method includes obtaining an indication of a measurement metric for a CLI measurement between the first network node and a second network node; and providing CLI information indicating at least one of one or more preferred beam pairs or one or more non-preferred beam pairs based on at least the measurement metric indicated for the CLI measurement.

In an aspect of the disclosure, an apparatus for wireless communication at a first network node is provided. The apparatus includes means for obtaining an indication of a measurement metric for a CLI measurement between the first network node and a second network node; and means for providing CLI information indicating at least one of one or more preferred beam pairs or one or more non-preferred beam pairs based on at least the measurement metric indicated for the CLI measurement.

In an aspect of the disclosure, an apparatus for wireless communication at a first network node is provided. The apparatus includes one or more memories and one or more processors coupled to the one or more memories and, based at least in part on information stored in the one or more memories, the one or more processors, individually or in any combination, are configured to cause the first network node to obtain an indication of a measurement metric for a CLI measurement between the first network node and a second network node; and provide CLI information indicating at least one of one or more preferred beam pairs or one or more non-preferred beam pairs based on at least the measurement metric indicated for the CLI measurement.

In an aspect of the disclosure, a computer-readable storage medium is provided. The computer-readable storage medium stores computer executable code at a first network node, the code when executed by one or more processors causes the first network node to: obtain an indication of a measurement metric for a CLI measurement between the first network node and a second network node; and provide CLI information indicating at least one of one or more preferred beam pairs or one or more non-preferred beam pairs based on at least the measurement metric indicated for the CLI measurement.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a 5G NR frame structure, in accordance with various aspects of the present disclosure.

FIG. 3B is a diagram illustrating an example of downlink (DL) channels within a 5G NR subframe, in accordance with various aspects of the present disclosure.

FIG. 3C is a diagram illustrating an example of a second subframe within a 5G NR frame structure, in accordance with various aspects of the present disclosure.

FIG. 3D is a diagram illustrating an example of uplink (UL) channels within a 5G NR subframe, in accordance with various aspects of the present disclosure.

FIG. 4 is a block diagram illustrating an example of a base station in communication with a user equipment (UE) in an access network, in accordance with various aspects of the present disclosure.

FIG. 5A illustrates an example of beam pair link (BPL) discovery and refinement, in accordance with various aspects of the present disclosure.

FIG. 5B illustrates another example of BPL discovery and refinement, in accordance with various aspects of the present disclosure.

FIG. 5C illustrates another example of BPL discovery and refinement, in accordance with various aspects of the present disclosure.

FIG. 6A, FIG. 6B, FIG. 6C, and FIG. 6D illustrate examples aspects of full-duplex communication, in accordance with various aspects of the present disclosure.

FIG. 7A, FIG. 7B, FIG. 7C, and FIG. 7D illustrate example aspects of full-duplex resource allocations, in accordance with various aspects of the present disclosure.

FIG. 8 illustrates an example of clutter for full-duplex communication, in accordance with various aspects of the present disclosure.

FIG. 9 illustrates examples of various types of interference in wireless communication, in accordance with various aspects of the present disclosure.

FIG. 10 illustrates examples of various types of interference in wireless communication including full-duplex communication, in accordance with various aspects of the present disclosure.

FIG. 11 illustrates various aspects of SBFD wireless communication, in accordance with various aspects of the present disclosure.

FIG. 12 is an example communication flow between a base station and a UE, in accordance with the teachings disclosed herein.

FIG. 13 is a flowchart of a method of wireless communication, in accordance with various aspects of the present disclosure.

FIG. 14 is a diagram illustrating an example of a hardware implementation for an example apparatus and/or network entity, in accordance with various aspects of the present disclosure.

FIG. 15 is a flowchart of a method of wireless communication, in accordance with various aspects of the present disclosure.

FIG. 16 is a diagram illustrating an example of a hardware implementation for an example apparatus and/or network entity, in accordance with various aspects of the present disclosure.

FIG. 17 is a flowchart of a method of wireless communication, in accordance with various aspects of the present disclosure.

FIG. 18 is a diagram illustrating an example of a hardware implementation for an example apparatus and/or network entity, in accordance with various aspects of the present disclosure.

### DETAILED DESCRIPTION

In some wireless communication systems, a first network node may experience cross link interference (CLI) from a second network node. For example, downlink communications transmitted by the second network node may interfere with uplink communications received by the first network node. Such interference may be referred to as “inter-gNB CLI” or “inter-base station CLI.” In some such scenarios, the first network node may sometimes be referred to as an “interfered” node or a “victim” node, and the second network node may sometimes be referred to as an “interfering” node or an “aggressor” node. Additionally, in some aspects, a network node may include a base station or a component of a base station.

In some aspects, inter-base station CLI may be particularly prevalent in the context of full-duplex (FD) communications in which one or both of the network nodes are configured to transmit and receive signals simultaneously.

In some aspects, after detecting inter-base station CLI, the interfered node may provide an indication of high CLI that is obtained by the interfering node. In some such aspects, the interfering node may then apply one or more CLI reduction mechanisms to mitigate the impact of the inter-base station CLI on communications. For example, based on the indication of the high CLI, the interfering node may avoid providing a downlink communication, may avoid using one or more downlink beams for the downlink communication, may avoid using one or more periodic time resources and/or frequency resources for the downlink communication, may perform a power back off to reduce a transmit power of the downlink communication, etc.

However, in some scenarios, the interfering base station may not perform the one or more CLI reduction mechanisms (or “CLI mitigation techniques”) upon detection of the inter-base station CLI. For example, the downlink traffic at the interfering node be associated with a priority level that is higher than the uplink traffic at the interfered node. As another example, the downlink traffic at the interfering node may be associated with a higher Quality of Service (QoS) class than the uplink traffic at the interfered node. In some such scenarios, other techniques for mitigating inter-base station CLI may be unsuccessful, or may result in lower reliability of the traffic associated with the higher priority.

Aspects disclosed herein provide techniques for indicating and mitigating inter-base station CLI. For example, the disclosed techniques may facilitate improving inter-base station messaging to enable both network nodes to determine which network node is performing the one or more CLI reduction mechanisms. The aspects presented herein improve the accuracy of wireless communication by providing base stations with additional information regarding interference caused to other base stations, and enables the coordination of mitigation efforts to reduce interference to uplink reception at base stations while balancing the importance of communication at an interfering base station.

In some aspects disclosed herein, the interfered node may provide a CLI report in response to one or more transmissions obtained from the interfering node. For example, based on measurements performed by the interfered node on the one or more transmissions, the interfered node may provide a CLI report that includes CLI information. In some aspects, the CLI information may include measurement values (e.g., CLI levels) of the measurements performed by the interfered node. In some aspects, the CLI information may additionally, or alternatively, indicate a set of preferred beams and/or a set of non-preferred beams. Each set of preferred/non-preferred beams may include zero, one, or more beams, respectively. Additionally, a beam may include a downlink beam at the interfering node and an uplink beam at the interfered node. A beam may be included in the respective sets of preferred/non-preferred beams based on the CLI level associated with the beam. Providing the interfering node with such beam information enables the interfering node to adjust downlink transmissions in a way that would improve uplink reception for the other node.

In some examples, the interfered node may additionally, or alternatively, provide an indication of a QoS class and/or a priority level of uplink traffic at the interfered node (e.g., from a UE) with the CLI report. The interfering node may use the indication of the received QoS and/or the received priority level of the uplink traffic to determine which network node is to perform the one or more CLI reduction mechanisms. Providing the priority information enables the interfering node to decide based on the relative priority of the downlink transmission, and balances the benefits of CLI mitigation with the potential reduction to the quality of the downlink communication. For example, the interfering node may compare the received QoS and/or the received priority level with a downlink QoS and/or a downlink priority level of the downlink traffic at the interfering node. For example, based on the result of the comparison, the interfering node may determine that the uplink traffic at the interfered node is associated with a priority that is higher than the priority associated with the downlink traffic. In other examples, the interfering node may determine that the uplink traffic and the downlink traffic are associated with a similar priority. In other examples, the interfering node may determine that the downlink traffic is associated with a priority that is higher than the priority associated with the uplink traffic.

In some aspects, based on the result of the comparison, the interfering node may determine which network node is to perform the one or more CLI reduction mechanisms. For example, when the interfering node determines that the downlink traffic is associated with a higher priority than the uplink traffic, the interfering node may determine for the interfered node to perform the one or more CLI reduction mechanisms. In other aspects, when the interfering node determines that the uplink traffic is associated with a higher priority than the downlink traffic, the interfering node may determine for the interfering node to perform the one or more CLI reduction mechanisms. In some aspects, when the interfering node determines that the uplink traffic and the downlink traffic are associated with a similar priority, the interfering node may be configured to perform the one or more CLI reduction mechanisms. In other examples, the interfering node may determine for the interfered node to perform the one or more CLI reduction mechanisms when the uplink traffic and the downlink traffic are associated with a similar priority.

In some aspects, the interfering node may output a response in response to the CLI report. For example, the interfering node may output an acknowledgement (ACK) or a negative ACK (NACK) after receiving the CLI report. In some aspects, the response may indicate to the interfered node which network node is to perform the one or more CLI reduction mechanisms. For example, the interfering node may output an ACK when the interfering node determines for itself to perform the one or more CLI reduction mechanisms. Otherwise, the interfering node may output a NACK to indicate to the interfered node that the interfered node is to perform the one or more CLI reduction mechanisms. For example, obtaining the NACK may cause the interfered node to perform the one or more CLI reduction mechanisms. The coordination between the network nodes enables a balance between CLI mitigation adjustments and different priorities for communication at the two nodes. By providing the interfered node with a response, the interfered node can determine whether to apply a mitigation action for the uplink communication.

In some aspects, the network node employing the one or more CLI reduction mechanisms may perform one or more mechanisms to mitigate the inter-base station CLI. For example, the network node may switch to a beam included in the set of preferred beams. In some examples, the network node may switch from a beam included in the set of non-preferred beams. In some examples, the network node may avoid using one or more periodic time resources and/or frequency resources for its respective communication. In some examples, the network node may avoid performing its respective communication. In some examples, the network node may perform a power back off procedure to reduce a transmit power associated with is respective communication.

In some aspects, the network node not performing the one or more CLI reduction mechanisms (e.g., the network node associated with the higher (or similar) priority traffic) may continue to operate as if inter-base station CLI is not present. For example, when the interfered node is employing the one or more CLI reduction mechanisms, the interfering node may continue outputting its downlink communication without changing beams, resources, and/or transmit power. Similarly, when the interfering node is employing the one or more CLI reduction mechanisms, the interfered node may not change the beams, resources, and/or transmit power associated with obtaining its uplink communication.

In some aspects, the interfered node and/or the interfering node may be configured with a measurement metric associated with the CLI information. For example, a CLI report configuration may indicate to the interfered node which measurement metric to include in the CLI report. The measurement metric may include a reference signal received power (RSRP) or a reference signal strength indicator (RSSI). However, other examples may include additional, or alternate, measurement metrics, such as a reference signal received quality (RSRQ). In some examples, the interfering node may provide the CLI report configuration with the measurement metric to the interfered node. In other examples, the interfered node and/or the interfering node may obtain the measurement metric to include in the CLI report from a different network node. For example, the measurement metric may be provided by at least one of a central unit (CU), a third-party node (e.g., an operations, administration, and maintenance (OAM) node), or a source distributed unit (DU) to a target DU. In this manner, the interfering node may be made aware of the metric for the CLI level included in the CLI report.

The aspects presented herein may enable network nodes to determine which network node is to perform one or more CLI reduction mechanisms upon detection of inter-base station CLI, which may improve communication performance, for example, by improving reliability for higher priority traffic when inter-base station CLI is present. The techniques described herein may lead to decreased inter-base station CLI, reduced noise, and higher reliability within the wireless communication system. In some aspects, a network node may reduce a transmit power used to perform wireless communications as compared to the transmit power used in the presence of inter-base station CLI, thereby reducing power consumption within the wireless communications system.

Although the following description provides examples directed to 5G NR (and, in particular, to information exchange including inter-base station CLI information), the concepts described herein may be applicable to other similar areas, such as 6G, 5G-advanced, LTE, LTE-A, CDMA, GSM, and/or other wireless technologies and/or future wireless technologies, for example, which include information exchange between two network nodes.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

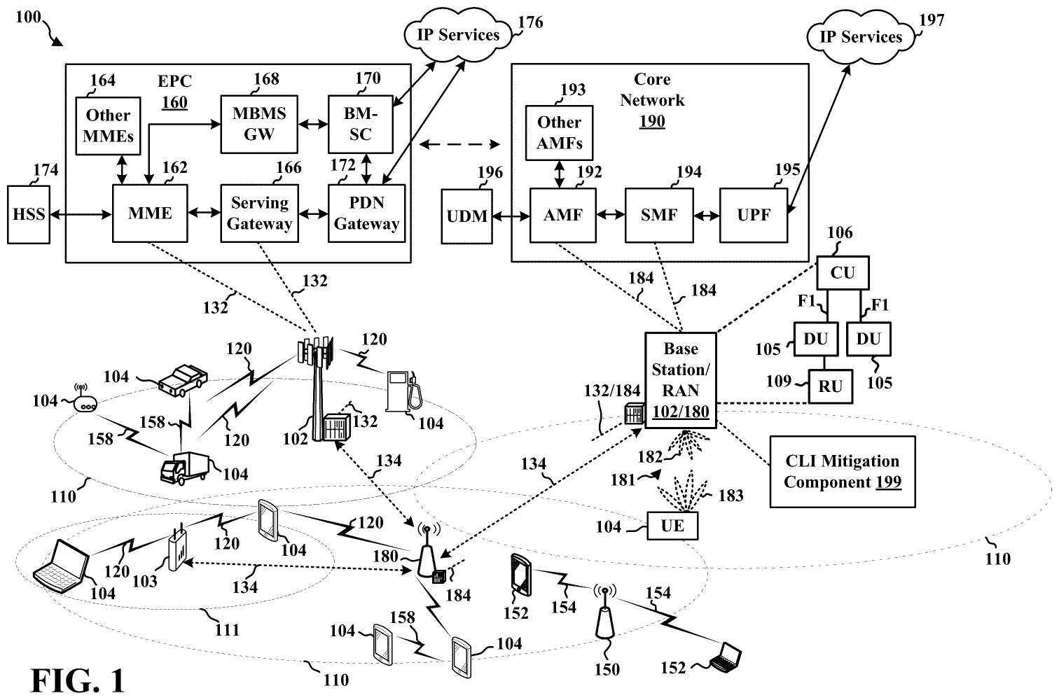

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell 103 may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 103 may operate in a licensed and/or an unlicensed frequency spectrum. When operating in an unlicensed frequency spectrum, the small cell 103 may employ NR and use the same unlicensed frequency spectrum (e.g., 5 GHz, or the like) as used by the AP 150. The small cell 103, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 103 or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 181 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 182. The UEs 104 may receive the beamformed signal from the base stations 180 in one or more receive directions 183. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a network entity, such as one of the base stations 102 or a component of a base station (e.g., a CU 106, a DU 105, and/or an RU 109), may be configured to manage or more aspects of wireless communication. For example, one of the base stations 102 may have a CLI mitigation component 199 that may be configured to facilitate inter-base station information exchange including traffic priority information and/or a measurement metric.

In certain aspects, the CLI mitigation component 199 may be configured to measure CLI from a transmission of a second network node for a set of one or more candidate beam pairs, each candidate beam pair of the set of one or more candidate beam pairs including an uplink beam of the first network node and a downlink beam of the second network node. The example CLI mitigation component 199 may also be configured to provide CLI information indicating at least one of one or more preferred beam pairs or one or more non-preferred beam pairs based on a CLI measurement from the transmission, the CLI information further indicating at least a first QoS or a first priority level for uplink traffic of the first network node.

In another aspect, the CLI mitigation component 199 may be configured to obtain CLI information of a first network node, the CLI information indicating at least one of one or more preferred beam pairs or one or more non-preferred beam pairs, the CLI information further indicating at least a first QoS or a first priority level for uplink traffic of the first network node. The example CLI mitigation component 199 may also be configured to adjust downlink communication based on a CLI reduction mechanism in response to the first QoS or the first priority level of the uplink traffic of the first network node being higher than or equal to a second QoS or a second priority level of downlink traffic of the second network node, or provide a response to the first network node in response to the first QoS or the first priority level of the uplink traffic of the first network node being less than the second QoS or the second priority level of the downlink traffic of the second network node.

In another aspect, the CLI mitigation component 199 may be configured obtain an indication of a measurement metric for a CLI measurement between the first network node and a second network node. The example CLI mitigation component 199 also be configured to provide CLI information indicating at least one of one or more preferred beam pairs or one or more non-preferred beam pairs based on at least the measurement metric indicated for the CLI measurement.

The aspects presented herein may enable network nodes to determine which network node is to perform one or more CLI reduction mechanisms upon detection of inter-base station CLI, which may improve communication performance, for example, by improving reliability for higher priority traffic when inter-base station CLI is present. The techniques described herein may lead to decreased inter-base station CLI, reduced noise, and higher reliability within the wireless communication system.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

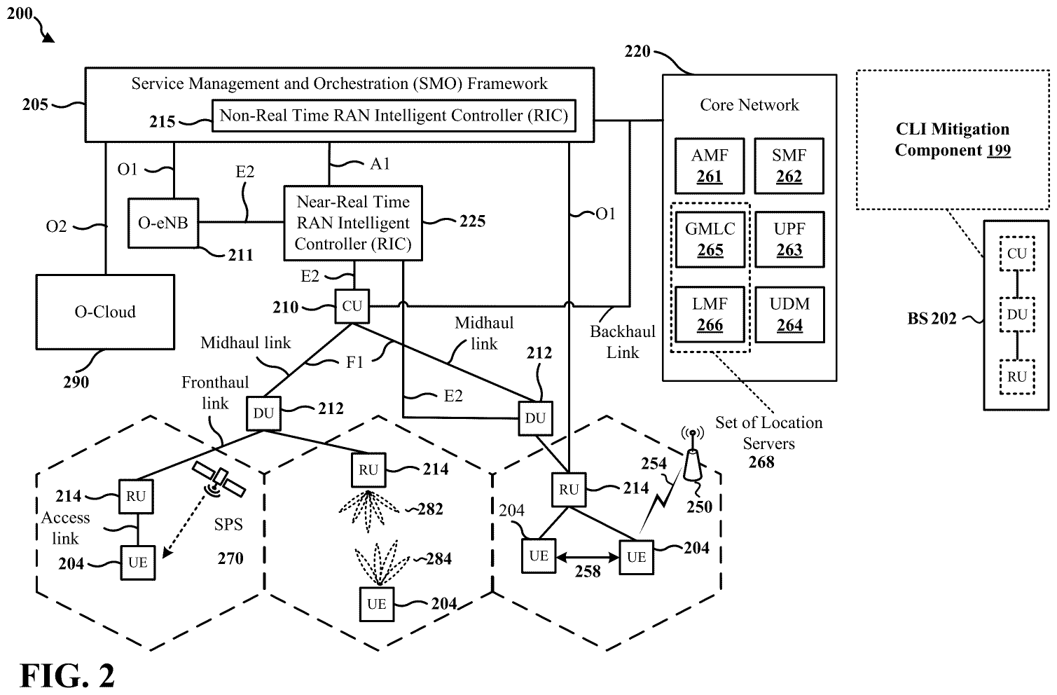

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 212) via respective midhaul links, such as an F1 interface. The DU 212 may communicate with one or more RUs (e.g., an RU 214) via respective fronthaul links. The RU 214 may communicate with respective UEs (e.g., a UE 204) via one or more radio frequency (RF) access links. In some implementations, the UE 204 may be simultaneously served by multiple RUs.

Each of the units, i.e., the CUs (e.g., a CU 210), the DUs (e.g., a DU 212), the RUs (e.g., an RU 214), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 212, as necessary, for network control and signaling.

The DU 212 may correspond to a logical unit that includes one or more base station functions to control the operation of one or more RUs. In some aspects, the DU 212 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 212 may further host one or more low PHY layers. Each layer (or module) can be implemented with an interface configured to communicate signals with other layers (and modules) hosted by the DU 212, or with the control functions hosted by the CU 210.

Lower-layer functionality can be implemented by one or more RUs. In some deployments, an RU 214, controlled by a DU 212, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 214 can be implemented to handle over the air (OTA) communication with one or more UEs (e.g., the UE 204). In some implementations, real-time and non-real-time aspects of control and user plane communication with the RU 214 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

At least one of the CU 210, the DU 212, and the RU 214 may be referred to as a base station 202. Accordingly, a base station 202 may include one or more of the CU 210, the DU 212, and the RU 214 (each component indicated with dotted lines to signify that each component may or may not be included in the base station 202). The base station 202 provides an access point to the core network 220 for a UE 204. The communication links between the RUs (e.g., the RU 214) and the UEs (e.g., the UE 204) may include uplink (UL) (also referred to as reverse link) transmissions from a UE 204 to an RU 214 and/or downlink (DL) (also referred to as forward link) transmissions from an RU 214 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

In certain aspects, a base station, such as the disaggregated base station 200, or a component of the base station, may include the CLI mitigation component 199 that may be configured to facilitate inter-base station information exchange including traffic priority information and/or a measurement metric, as described in connection with the example of FIG. 1.

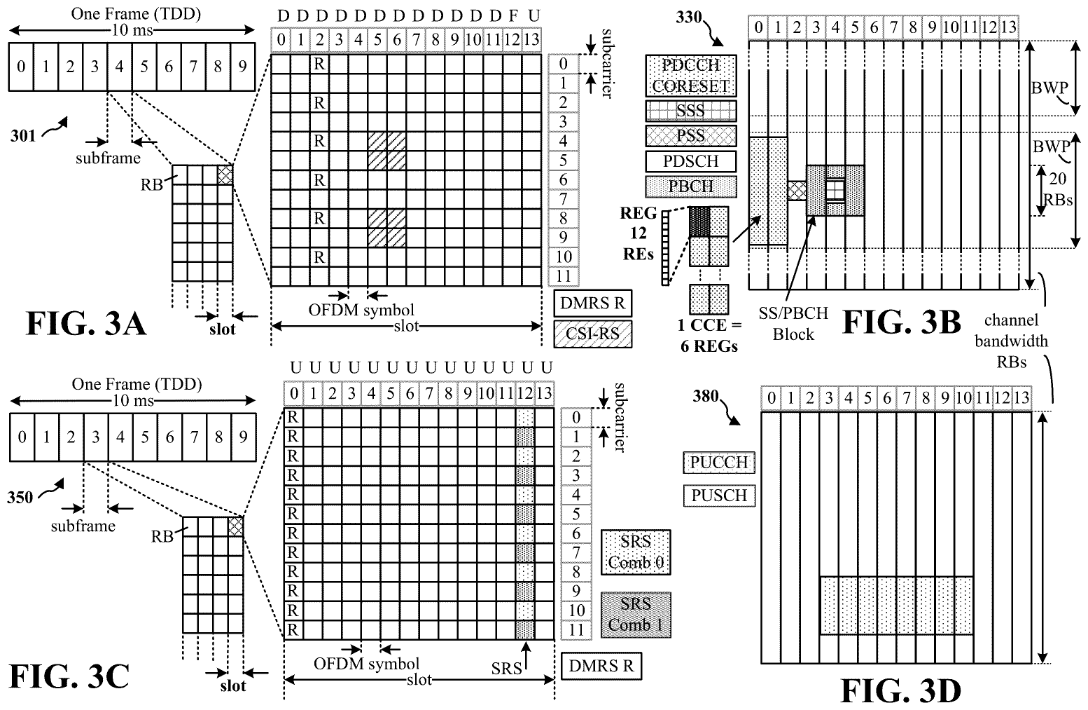

FIG. 3A is a diagram 301 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

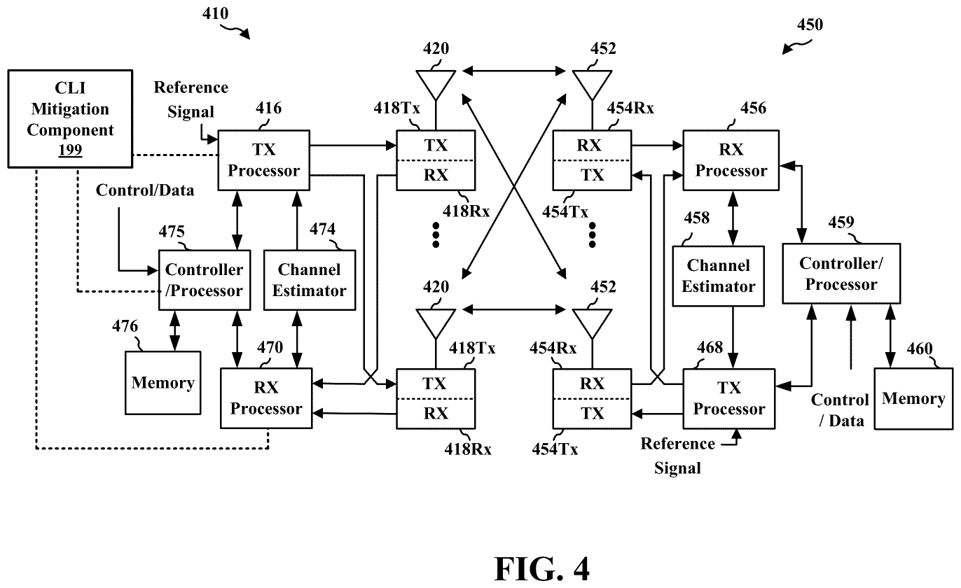

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the CLI mitigation component 199 of FIG. 1.

A beamforming technology (e.g., 5G NR mmW technology) may use beam management procedures, such as beam measurements and beam switches, to maintain a quality of a link between a first network entity and a second network entity (e.g., a backhaul link between a first base station and a second base station, an access link between a base station and a UE, or a sidelink communication link between a first UE and a second UE) at a sufficient level. Beam management procedures aim to support mobility and the selection of the best beam pairing (or beam pair link (BPL)) between the first network entity and the second network entity. Beam selection may be based on a number of considerations including logical state, power saving, robustness, mobility, throughput, etc. For example, wide beams may be used for initial connection and for coverage/mobility and narrow beams may be used for high throughput scenarios with low mobility.

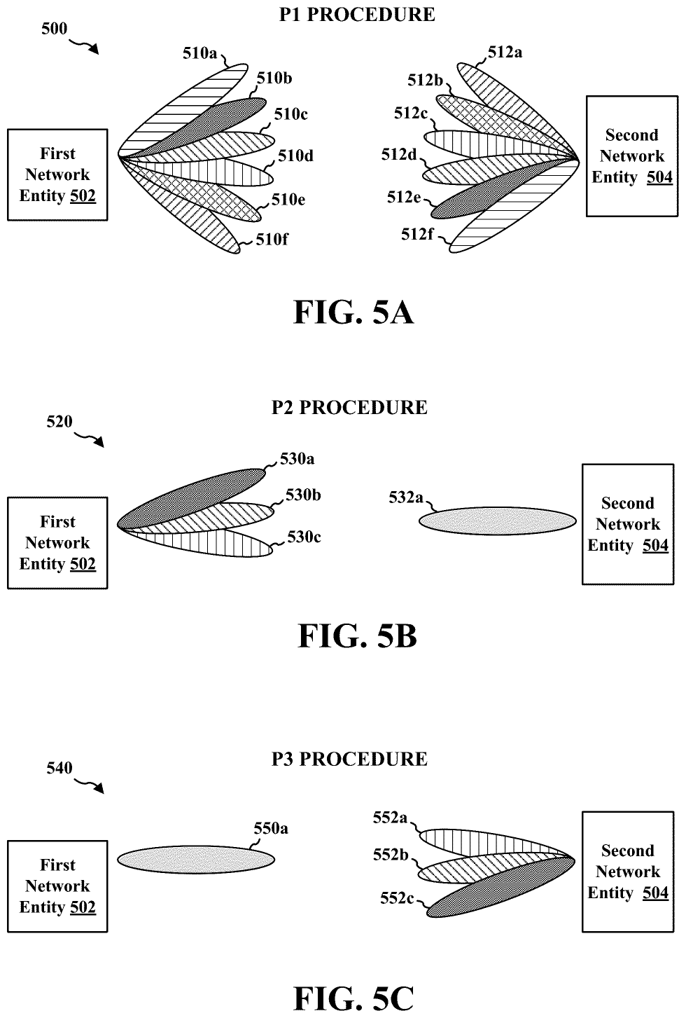

FIG. 5A, FIG. 5B, and FIG. 5C illustrate an example of BPL discovery and refinement between a first network entity 502 and a second network entity 504, as presented herein. In 5G NR, a P1 procedure, a P2 procedure, and a P3 procedure are used for BPL discovery and refinement.

A P1 procedure enables the discovery of new BPLs. Referring to FIG. 5A, in a P1 procedure 500, the first network entity 502 transmits different symbols of a reference signal (e.g., a P1 signal), each beamformed in a different spatial direction. For example, the first network entity 502 may transmit beams using different transmit beams (e.g., transmit beams 510a, 510b, 510c, 510d, 510e, 510f) over time in different directions. The P1 signal may be a periodic signal. For successful reception of at least a symbol of the P1 signal, the second network entity 504 searches for an appropriate receive beam. The second network entity 504 may search using available receive beams (e.g., receive beams 512a, 512b, 512c, 512d, 512d, 512e, 512f) and applying a different receive beam during each occurrence of the periodic P1 signal.

Once the second network entity 504 has succeeded in receiving a symbol of the P1 signal, the second network entity 504 has discovered a BPL. In some aspects, the second network entity 504 may not want to wait until it has found the best receive beam, since this may delay further actions. The second network entity 504 may measure a signal strength (e.g., a reference signal receive power (RSRP) and/or a signal to interference and noise ratio (SINR)) and report the symbol index together with the signal strength to the first network entity 502. Such a report may contain the findings of one or more BPLs. In an example, the second network entity 504 may determine a received signal having a high signal strength. The second network entity 504 may not know which transmit beam the first network entity 502 used to transmit. However, the second network entity 504 may report to the first network entity 502 the time at which the signal having a high signal strength was observed. The first network entity 502 may receive this report and may determine which transmit beam the first network entity 502 used at the given time.

The first network entity 502 may then perform P2 and P3 procedures to refine an individual BPL. Referring to FIG. 5B, a P2 procedure 520 refines the beam (transmit beam) of a BPL at the first network entity 502. The first network entity 502 may transmit a set of symbols of a reference signal with different beams that are spatially close to the beam of the BPL (e.g., the first network entity 502 may perform a sweep using neighboring beams around the selected beam). For example, the first network entity 502 may transmit a plurality of transmit beams (e.g., beams 530a, 530b, and 530c) over a consecutive sequence of symbols, with a different beam per symbol. In the P2 procedure 520, the second network entity 504 keeps a receive beam (e.g., a beam 532a) constant. Thus, the second network entity 504 uses the same beam as in the BPL reported via the P1 procedure 500. The beams used by the first network entity 502 for the P2 procedure 520 may be different from those used for the P1 procedure in that they may be spaced closer together or they may be more focused. The second network entity 504 may measure the signal strength (e.g., the RSRP and/or the SINR) for the various beams (e.g., the beams 530a, 530b, and 530c) and indicate the strongest beam and/or the highest signal strength to the first network entity 502. Additionally, or alternatively, the second network entity 504 may indicate all signal strengths measured for the beams. The second network entity 504 may indicate such information via a CSI-RS resource indicator (CRI) feedback message, which may contain the signal strengths of the receive beams (e.g., the beams 530a, 530b, 530c) in a sorted manner. The first network entity 502 may switch an active beam to the strongest beam reported, thus keeping the signal strength of the BPL at a highest level and supporting low mobility. If the transmit beams used for the P2 procedure 520 are spatially close (or even partially overlapped), no beam switch notification may be sent to the second network entity 504.

Referring to FIG. 5C, a P3 procedure 540 refines the beam (receive beam) of a BPL at the second network entity 504. In this example, the first network entity 502 transmits a same transmit beam 550a over a consecutive sequence of symbols. The second network entity 504 may use this opportunity to refine the receive beam by checking a strength of multiple receive beams (e.g., from the same or different panels). That is, while the transmit beam stays constant at the first network entity 502, the second network entity 504 may scan using different receive beams (e.g., the second network entity 504 performs a sweep using neighboring beams, such as beams 552a, 552b, and 552c). The second network entity 504 may measure the signal strength (e.g., the RSRP and/or the SINR) of each receive beam and identify the best beam. Afterwards, the second network entity 504 may use the best beam for the BPL. The second network entity 504 may or may not send a report of signal strength(s) of the receive beam to the first network entity 502. By the end of the P2 and P3 procedures, the refined transmit beam at the first network entity 502 and the refined receive beam at the second network entity 504 maximize the signal strength of the BPL.

Wireless communication systems may be configured to share available system resources and provide various communication services (e.g., telephony, video, data, messaging, broadcasts, etc.) based on, for example, multiple-access technologies that support communication with multiple users. In one example, a wireless device may communicate in a full-duplex mode in which uplink communication and downlink communication may be exchanged in a same frequency band at overlapping times.

Full-duplex mode communication may be supported by a UE and/or a network node (e.g., a base station or a component of a base station, as described in connection with the examples of FIG. 1 and FIG. 2). For example, a UE may transmit uplink communication from one antenna panel and may receive downlink communication with another antenna panel. In additional or alternate examples, a network entity may transmit a downlink communication to a first UE using a first antenna panel and may receive an uplink communication from a second UE using a second antenna panel. For another example, a network entity may transmit a downlink communication to a UE using a first antenna panel and may receive an uplink communication from the same UE using a second antenna panel. In some examples, the full-duplex mode communication may be conditional on beam or spatial separation or other conditions.

Full-duplex mode communication may reduce latency. For example, full-duplex mode communication may enable a UE to receive a downlink signal, e.g., in a downlink subband, in an uplink only slot, which can reduce the latency for downlink communications. Additionally, or alternatively, full-duplex mode communication may enable the UE to transmit an uplink signal, e.g., in an uplink subband, in a downlink only slot, which can reduce the latency for uplink communications. Full-duplex mode communication may improve spectrum efficiency, such as spectrum efficiency per cell or per UE. Full-duplex mode communication may enable more efficient use of wireless resources. For example, because full-duplex mode communication supports transmission and reception of information at a wireless device in a manner that overlaps in time, spectral efficiency may be improved relative to the spectral efficiency of half-duplex mode communication, which supports transmission or reception of information in one direction at a time without overlapping uplink and downlink communication.

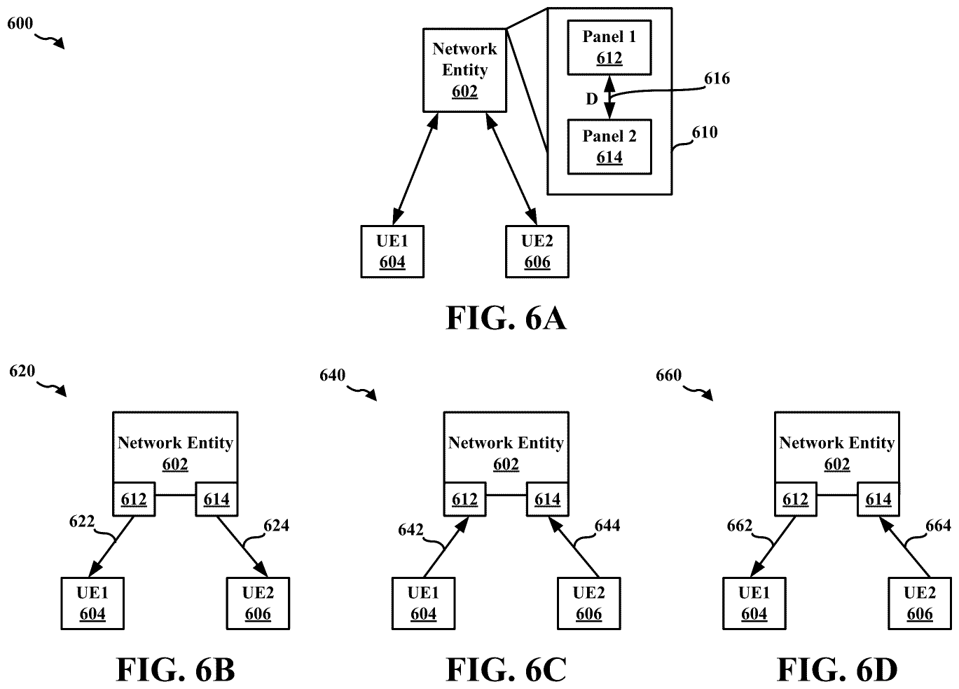

FIG. 6A illustrates an example of full-duplex mode communication 600 in which a network entity 602 is in communication with a first UE 604 and a second UE 606, as presented herein. One or more aspects described for the network entity 602 may be performed by a component of a base station or a network entity, such as a CU, a DU, and/or an RU. In the example of FIG. 6A, the network entity 602 is a full-duplex network entity, whereas the first UE 604 and the second UE 606 may be configured as either a half-duplex UE or a full-duplex UE. As shown in FIG. 6A, the network entity 602 includes an antenna array 610. The antenna array 610 of FIG. 6A includes a first antenna panel 612 (“Panel 1”), a second antenna panel 614 (“Panel 2”), and a physical separation 616 (“D”) between the first antenna panel 612 and the second antenna panel 614. Each of the two antenna panels may be a subarray of antennas. A given panel may transmit and/or receive a beam or a beam group.

FIG. 6B, FIG. 6C, and FIG. 6D illustrate different examples of communication between the network entity 602, the first UE 604, and the second UE 606 using the example antenna array 610 of FIG. 6A. The communications may employ multi-user MIMO (MU-MIMO).

FIG. 6B illustrates a first example 620 of communication in which the antenna array 610 is configured for downlink communication, as presented herein. For example, the first antenna panel 612 may be configured to transmit a first downlink communication 622 to the first UE 604 and the second antenna panel 614 may be configured to transmit a second downlink communication 624 to the second UE 606.

FIG. 6C illustrates a second example 640 of communication in which the antenna array 610 is configured for uplink communication, as presented herein. For example, the first antenna panel 612 may be configured to receive a first uplink communication 642 from the first UE 604 and the second antenna panel 614 may be configured to receive a second uplink communication 644 from the second UE 606.

FIG. 6D illustrates a third example 660 of communication in which the antenna array 610 is configured for full-duplex mode communication, as presented herein. For example, the first antenna panel 612 may be configured to transmit a downlink communication 662 to the first UE 604 and the second antenna panel 614 may be configured to receive an uplink communication 664 from the second UE 606.

Full-duplex mode communication enables the wireless device to achieve increased throughput and spectral efficiency relative to half-duplex mode communication. However, full-duplex mode communication may also be associated with higher levels of interference, which may result in a reduced signal to interference and noise ratio (SINR).

Full-duplex mode communication may occur in a same frequency band. When a wireless device operates in a full-duplex mode, uplink communication and downlink communication may be in a same frequency subband, in partially overlapping frequency subbands, or in different frequency subbands. An uplink communication may be communicated using uplink resources and a downlink communication may be communicated using downlink resources. A wireless device may implement full-duplex mode communication via in-band full-duplex (IBFD) or subband full-duplex (SBFD). When employing the IBFD mode, the wireless device transmits and receives on overlapping (or partially overlapping) time resources and frequency resources. That is, a downlink communication and an uplink communication share, or partially share, the same time resources/frequency resources. When employing the SBFD mode, the wireless device transmits and receives at the same time, but using different frequency resources. That is, a downlink communication and an uplink communication overlap in time resources, but are non-overlapping with respect to frequency resources. Thus, subband full-duplex may also be referred to as “subband non-overlapping full-duplex.”

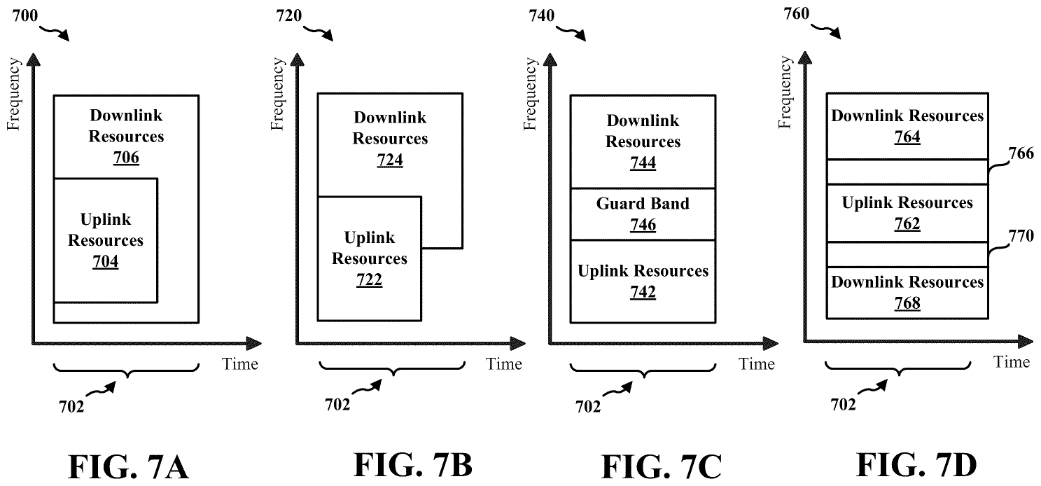

FIG. 7A, FIG. 7B, FIG. 7C, and FIG. 7D illustrate various examples of resource allocations for IBFD operation and SBFD operation, as presented herein. In the examples of FIG. FIG. 7A, FIG. 7B, FIG. 7C, and FIG. 7D, the resource allocations are for one time unit 702. Downlink resources and uplink resources that are immediately adjacent to each other correspond to a guard band width of 0 frequency domain resources. FIG. 7A illustrates an example first resource allocation 700 and facilitates IBFD operation. FIG. 7B illustrates an example second resource allocation 720 and facilitates IBFD operation. FIB. 7C illustrates an example third resource allocation 740 and facilitates SBFD operation. FIB. 7D illustrates an example fourth resource allocation 760 and facilitates SBFD operation.

In the first resource allocation 700 of FIG. 7A, resources for uplink communication (e.g., resources used for transmitting or receiving uplink information) and resources for downlink communication (e.g., resources used for transmitting or receiving downlink information) are fully overlapping in the frequency domain. For example, uplink resources 704 fully overlap with downlink resources 706. In the second resource allocation 720 of FIG. 7B, uplink resources 722 partially overlap with downlink resources 724 in the frequency domain.

In the third resource allocation 740 of FIG. 7C and the fourth resource allocation 760 of FIG. 7D, resources for uplink communication and resources for downlink communication may overlap in time using different frequency subbands. For example, in the third resource allocation 740, uplink resources 742 are separated from downlink resources 744 by a guard band 746. In the fourth resource allocation 760 of FIG. 7D, resources for uplink communication and resources for downlink communication may overlap in time using different frequency subbands. For example, uplink resources 762 are separated from first downlink resources 764 by a first guard band 766. The uplink resources 762 are separated from second downlink resources 768 by a second guard band 770. The guard bands may be frequency domain resources, or a gap in frequency domain resources, provided between the uplink resources and the downlink resources of FIG. 7C and FIG. 7D. Separating the uplink resources and the downlink resources with the respective guard band may help to reduce self-interference.

In some examples, the uplink resources and the downlink resources allocated for SBFD operation may be configured within a same TDD time resource unit. In contrast, the uplink resources and/or the downlink resources allocated for IBFD operation may be configured across two or more TDD time resource units.

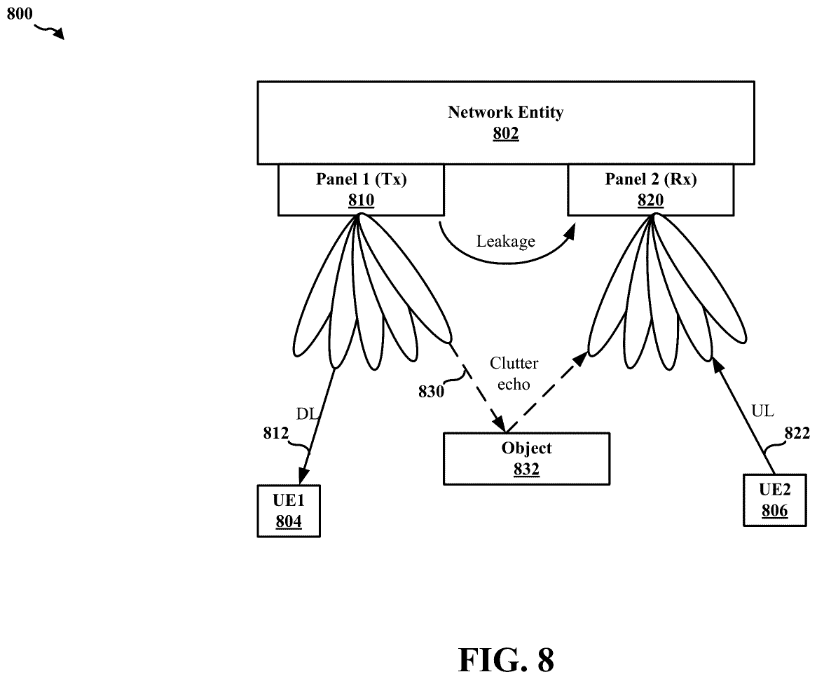

FIGS. 8 to 11 illustrate different types of interference that may occur in wireless communications systems. FIG. 8 is a diagram 800 illustrating an example network entity 802 that supports full-duplex mode communication and includes multiple antenna panels, as presented herein. One or more aspects described for the network entity 802 may be performed by a component of a base station or a network entity, such as a CU, a DU, and/or an RU. In the illustrated example of FIG. 8, the network entity 802 is in full-duplex mode communication with a first UE 804 and a second UE 806. For example, a first antenna panel 810 (“Panel 1”) may be configured to transmit a downlink communication 812 to the first UE 804. Additionally, a second antenna panel 820 (“Panel 2”) may be configured to receive an uplink communication 822 from the second UE 806. In the example of FIG. 8, the antenna panels may be configured so that at least a portion of the downlink communication 812 and the uplink communication 822 overlap in the time domain.

In some examples, self-interference may occur when a transmitted signal leaks into a receive port. For example, in the example of FIG. 8, leakage is shown from the first antenna panel 810, which is configured to transmit, and into the second antenna panel 820, which is configured to receive.

Additionally, or alternatively, self-interference may occur when an object reflects a transmitted signal back to a receive port, which may be referred to as “clutter interference.” For example, in the example of FIG. 8, a signal 830 transmitted by the first antenna panel 810 toward the first UE 804 may reflect off of an object 832 and into the second antenna panel 820, which may cause a clutter echo effect. The reflected signal may cause interference with an uplink communication transmitted by the second UE 806 toward the second antenna panel 820, such as the uplink communication 822.

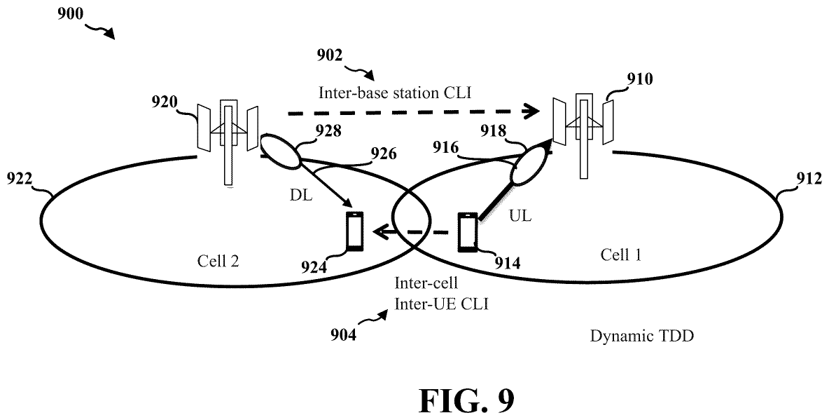

FIG. 9 illustrates a first inter-base station CLI environment 900 including a dynamic TDD frame structure, as presented herein. In the example of FIG. 9, a first network entity 910 provides communication coverage to a first cell 912 (“Cell 1”). As shown in FIG. 9, a first UE 914 is within coverage of the first network entity 910 and is transmitting an uplink communication 916. In the example of FIG. 9, the first network entity 910 obtains the uplink communication 916 via an uplink beam 918.

Similar to the first network entity 910, a second network entity 920 of FIG. 9 provides communication coverage to a second cell 922 (“Cell 2”). As shown in FIG. 9, a second UE 924 is within coverage of the second network entity 920 and is receiving a downlink communication 926. In the example of FIG. 9, the second network entity 920 provides the downlink communication 926 via a downlink beam 928.

Although the first network entity 910 and the second network entity 920 are not communicating with each other and the first UE 914 and the second UE 924 are not communicating with each other, downlink communications may interfere with obtaining of uplink communications. For example, the output of the downlink communication 926 by the second network entity 920 (e.g., the interfering base station) may interfere with the ability of the first network entity 910 (e.g., the interfered base station) to obtain the uplink communication 916 from the first UE 914. Similarly, the output of the uplink communication 916 by the first UE 914 may interfere with the ability of the second UE 924 to receive the downlink communication 926 from the second network entity 920. The interference between the second network entity 920 and the first network entity 910 may be referred to as inter-base station CLI 902 (“Inter-gNB CLI”). Additionally, interference between the first UE 914 and the second UE 924 may be referred to as inter-cell, inter-UE CLI 904.

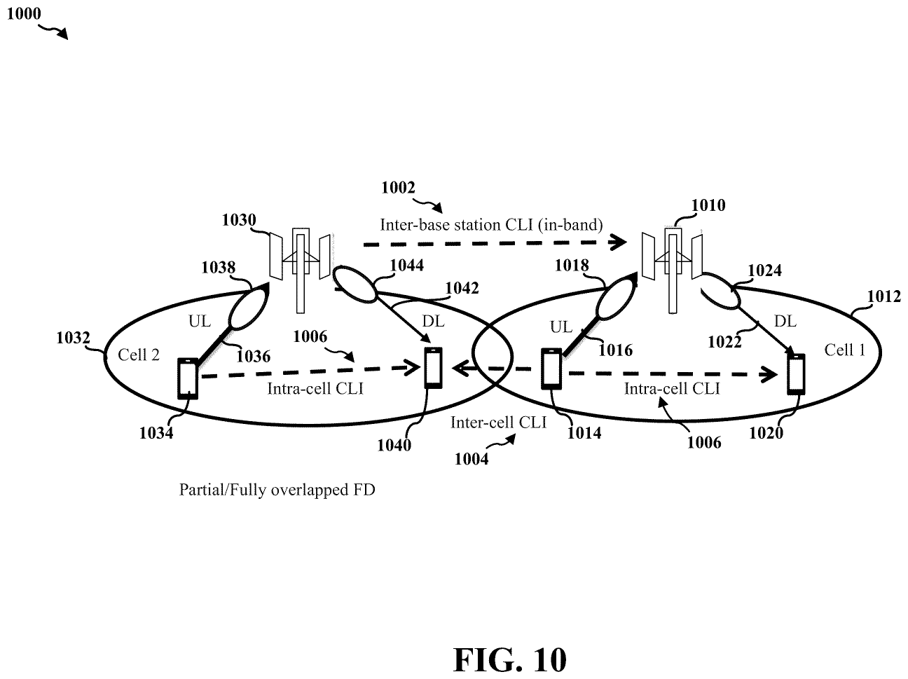

FIG. 10 illustrates a second inter-base station CLI environment 1000 including full-duplex mode communication, as presented herein. In the example of FIG. 10, a first network entity 1010 provides communication coverage to a first cell 1012 (“Cell 1”) including a first UE 1014 and a second UE 1020. As shown in FIG. 10, the first UE 1014 is transmitting an uplink communication 1016 that is obtained by the first network entity 1010 via an uplink beam 1018. Additionally, the first network entity 1010 is outputting, via a downlink beam 1024, a downlink communication 1022 that is received by the second UE 1020.

Similar to the first network entity 1010, a second network entity 1030 provides communication coverage to a second cell 1032 (“Cell 2”) including a third UE 1034 and a fourth UE 1040. As shown in FIG. 10, the third UE 1034 is transmitting an uplink communication 1036 that is obtained by the second network entity 1030 via an uplink beam 1038. Additionally, the second network entity 1030 is outputting, via a downlink beam 1044, a downlink communication 1042 that is received by the fourth UE 1040.

In the illustrated example of FIG. 10, the first network entity 1010 and the second network entity 1030 are each in full-duplex mode communication. For example, the full-duplex mode communication may include partially or fully overlapped full-duplex mode communication, as described in connection with the examples of FIG. 7A and FIG. 7B. In the example of FIG. 10, the first network entity 1010 may be configured so that at least a portion of the uplink communication 1016 and the downlink communication 1022 overlap in the time domain. Similarly, the second network entity 1030 may be configured so that at least a portion of the uplink communication 1036 and the downlink communication 1042 may overlap in the time domain.

Similar to the example of FIG. 9, the downlink communications of FIG. 10 may interfere with the ability of devices to obtain uplink communications. For example, the output of the downlink communication 1042 by the second network entity 1030 (e.g., the interfering base station) may interfere with the ability of the first network entity 1010 (e.g., the interfered base station) to obtain the uplink communication 1016 from the first UE 1014. Similarly, the output of the uplink communication 1016 by the first UE 1014 may interfere with the ability of the second UE 1020 to receive the downlink communication 1022 from the first network entity 1010. The output of the uplink communication 1016 may also interfere with the ability of the fourth UE 1040 to receive the downlink communication 1042 from the second network entity 1030. As shown in FIG. 10, the transmitting of the uplink communication 1036 by the third UE 1034 may interfere with the ability of the fourth UE 1040 to receive the downlink communication 1042 from the second network entity 1030. The interference between the second network entity 1030 and the first network entity 1010 may be referred to as inter-base station CLI 1002 (“Inter-gNB CLI”). In the example of FIG. 10, the inter-base station CLI 1002 may be in-band CLI as frequency resources between the uplink communications and the downlink communications may be partially or fully overlapping in the time domain (e.g., as shown in the examples of FIG. 7A and FIG. 7B). Additionally, interference 1004 between the first UE 1014 and the third UE 1034 may be referred to as inter-cell CLI. The first UE 1014 and the third UE 1034 may also cause interference 1006 with the second UE 1020 and the fourth UE 1040, respectively. The interference 1006 may also be referred to as intra-cell CLI.

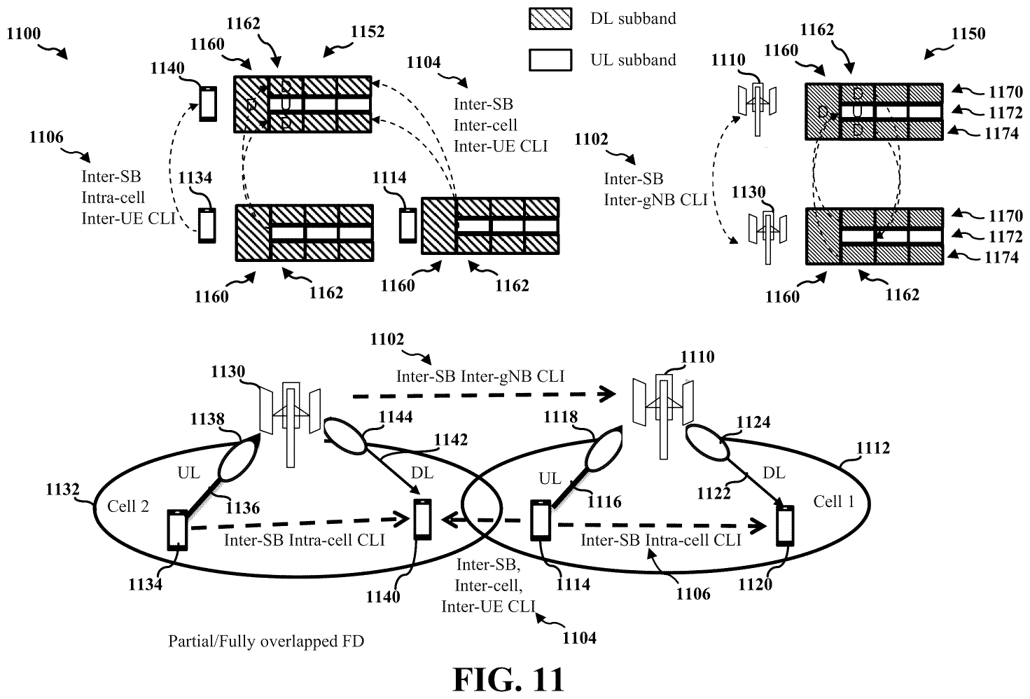

FIG. 11 illustrates a third inter-base station CLI environment 1100 including full-duplex mode communication, as presented herein. Similar to the example of FIG. 10, a first network entity 1110 provides communication coverage to a first cell 1112 (“Cell 1”) including a first UE 1114 and a second UE 1120. The first UE 1014 transmits an uplink communication 1116 that is obtained by the first network entity 1110 via an uplink beam 1118. Additionally, the first network entity 1110 outputs, via a downlink beam 1124, a downlink communication 1122 that is received by the second UE 1120. In the example of FIG. 11, a second network entity 1130 provides communication coverage to a second cell 1132 (“Cell 2”) including a third UE 1134 and a fourth UE 1140. The third UE 1134 transmits an uplink communication 1136 that is obtained by the second network entity 1130 via an uplink beam 1138. Additionally, the second network entity 1130 outputs, via a downlink beam 1144, a downlink communication 1142 that is received by the fourth UE 1140.

In the illustrated example of FIG. 11, the first network entity 1110 and the second network entity are each in full-duplex mode communication and, in particular, in SBFD mode communication, as described in connection with the examples of FIG. 7C and FIG. 7D. For example, the first network entity 1110 may be configured so that at least a portion of the uplink communication 1116 and the downlink communication 1122 overlap in the time domain, but are non-overlapping in the frequency domain. Similarly, the second network entity 1130 may be configured so that at least a portion of the uplink communication 1136 and the downlink communication 1142 may overlap in the time domain, but are non-overlapping in the frequency domain.

Similar to the examples of FIG. 9 and FIG. 10, the downlink communications of FIG. 11 may interfere with the ability of devices to obtain uplink communications. For example, the output of the downlink communication 1142 by the second network entity 1130 (e.g., the interfering base station) may interfere with the ability of the first network entity 1110 (e.g., the interfered base station) to obtain the uplink communication 1116 from the first UE 1114. Similarly, the output of the uplink communication 1116 by the first UE 1114 may interfere with the ability of the second UE 1120 to receive the downlink communication 1022, and may also interfere with the ability of the fourth UE 1140 to receive the downlink communication 1142. Additionally, the uplink communication 1136 by the third UE 1134 may interfere with the ability of the fourth UE 1140 to receive the downlink communication 1142 from the second network entity 1130.

In the example of FIG. 11, interference 1102 between the network entities may be referred to as inter-base station CLI (“Inter-gNB CLI”). Additionally, interference 1104 between the first UE 1114 and the third UE 1134 may be referred to as inter-cell CLI. The first UE 1114 and the third UE 1134 may also cause interference 1106 with the second UE 1120 and the fourth UE 1140, respectively. The interference 1106 may also be referred to as intra-cell CLI.

In the example of FIG. 11, the illustrated interferences may also be inter-subband as the downlink frequency resources are non-overlapping with the uplink frequency resources. For example, FIG. 11 includes a first resources diagram 1150 and a second resources diagram 1152. The first resources diagram 1150 illustrates the interference 1102 between the second network entity 1130 and the first network entity 1110. The second resources diagram 1152 illustrates the interference between the first UE 1114 and the fourth UE 1140 (e.g., the interference 1104), and between the third UE 1134 and the fourth UE 1140 (e.g., the interference 1106).

In the illustrated example of FIG. 11, the first resources diagram 1150 and the second resources diagram 1152 each include a first time unit 1160 and a second time unit 1162. As shown in FIG. 11, the first time unit 1160 is a downlink resource in which all of the frequency resources are allocated for downlink communication. The second time unit 1162 is an SBFD resource in which a first subband 1170 is allocated for downlink communication, a second subband 1172 is allocated for uplink communication, and a third subband 1174 is allocated for downlink communication. Although not illustrated in the example of FIG. 11, it may be appreciated that guard bands may be located between the first subband 1170 and the second subband 1172, and between the second subband 1172 and the third subband 1174 (e.g., as shown in the example of FIG. 7D).

In the illustrated example first resources diagram 1150 of FIG. 11, during the second time unit 1162, the second network entity 1130 may use one or more downlink resources of the first subband 1170 and/or the third subband 1174 to output a downlink communication, such as the downlink communication 1142 to the fourth UE 1140. Additionally, the first network entity 1110 may use one or more uplink resources of the second subband 1172 to obtain an uplink communication, such as the uplink communication 1116 from the first UE 1114. As shown in FIG. 11, the downlink communication 1142 may interfere with the uplink communication 1116, for example, when one or more downlink resources of the first subband 1170 and/or the third subband 1174 overlap, at least partially, with one or more uplink resources of the second subband 1172. Thus, the interference 1102 may also be referred to as inter-SB, inter-base station CLI, as the interference is between subbands (SBs) and also between base stations.

The example second resources diagram 1152 of FIG. 11 illustrates resource allocations for communications between the UEs. For example, during the second time unit 1162, the fourth UE 1140 may use one or more downlink resources of the first subband 1170 and/or the third subband 1174 to receive a downlink communication, such as the downlink communication 1142 from the second network entity 1130. Additionally, the first UE 1114 and the third UE 1134 may use one or more uplink resources of the second subband 1172 to transmit uplink communications, such as the uplink communication 1116 and the uplink communication 1136, respectively. Similar to the example of the first resources diagram 1150 interference (e.g., CLI) may be caused when one or more resources of a first subband overlap with one or more resources of a second subband. For example, and with respect to the uplink communication 1116, one or more uplink resources from the second subband 1172 may overlap with one or more downlink resources of the first subband 1170 and/or the third subband 1174 at the fourth UE 1140 and, thus, the interference 1104 may also be referred to as inter-SB, inter-cell, inter-UE CLI, as the interference is between subbands (SBs), is between cells, and is between UEs. Additionally, and with respect to the uplink communication 1136, one or more uplink resources from the second subband 1172 may overlap with one or more downlink resources of the first subband 1170 and/or the third subband 1174 at the fourth UE 1140 and, thus, the interference 1106 may also be referred to as inter-SB, intra-cell, inter-UE CLI, as the interference is between subbands (SBs), is within the same cell, and is between UEs.

In some aspects, the interfered node and/or the interfering node may be configured with a measurement metric associated with the CLI information. For example, a CLI report configuration may indicate to the interfered node which measurement metric to include in the CLI report. The measurement metric may include a reference signal received power (RSRP) or a reference signal strength indicator (RSSI). However, other examples may include additional, or alternate, measurement metrics, such as a reference signal received quality (RSRQ). In some examples, the interfering node may provide the CLI report configuration with the measurement metric to the interfered node. In other examples, the interfered node and/or the interfering node may obtain the measurement metric to include in the CLI report from a different network node. For example, the measurement metric may be provided by at least one of a central unit (CU), a third-party node (e.g., an operations, administration, and maintenance (OAM) node), or a source distributed unit (DU) to a target DU. In this manner, the interfering node may be made aware of the metric for the CLI level included in the CLI report.

Based on the measurement results, a base station or a central coordinator may identify one or more compatible downlink beam(s) of an interfering base station that will cause less interference (e.g., negligible interference) to one or more uplink beams of an interfered base station. In some aspects, the base station or the central coordinator may identify the compatible beam(s) for each interfering base station, e.g., in a per base station manner. The central coordinator may refer to a network node performing the identification. In some aspects, the central coordinator may be a base station or a component of a base station. In other aspects, the central coordinator may be a different network node.

In some aspects, a beam pair, e.g. an inter-base station beam pair may be identified and/or signaled associated with a QoS class and/or a traffic priority level. As an example, an interfering base station may transmit a measurement reference signal to enable the interfered base station to measure the corresponding interference. The interfered base station may measure the interference for each of multiple downlink and uplink beam pairs, e.g. each beam pair including an uplink beam of the interfered base station and a downlink beam of the interfering base station. For each beam pair, the interfered base station measures interference caused to uplink reception on the uplink beam based on a downlink transmission on the downlink beam by the interfering base station.

Based on the measurement results, the interfered base station (or a central coordinator) may signal, e.g., indicate, a preferred set of one or more downlink beams or a non-preferred set of one or more downlink for each interfering base station. In some aspects, the interfered base station or the central coordinator may identify one or more additional operation parameters of the interfering base station that would reduce or avoid interference to the interfered base station. The interfering base station may use the indication of the beam(s) and/or the operation parameters to help avoid causing interference to the interfered base station.

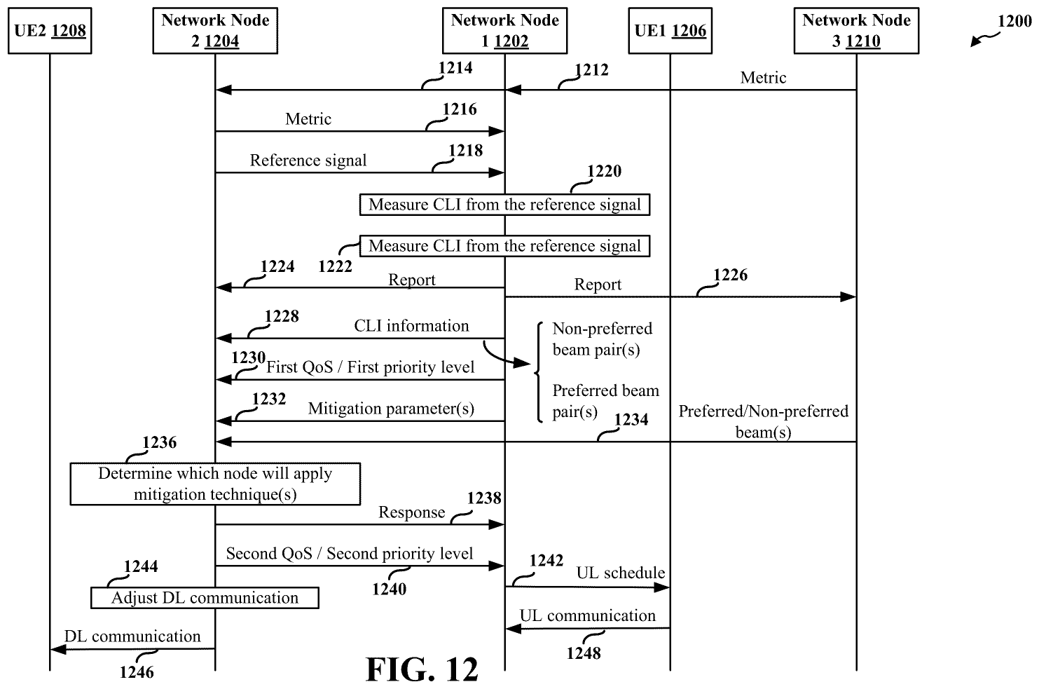

FIG. 12 illustrates an example communication flow 1200 between a first network node 1202 (“network node 1”), a second network node 1204 (“network node 2”), a third network node 1210 (“network node 3”), a first UE 1206 (“UE 1”), and a second UE 1208 (“UE 2”), as presented herein. One or more aspects described for the first network node 1202 and/or the second network node 1204 may be performed by a component of a base station or a network entity, such as a CU, a DU, and/or an RU. In the example of FIG. 12, the network nodes support full-duplex mode communication, and the UEs may support half-duplex mode communication and/or full-duplex mode communication. In the illustrated example of FIG. 12, the communication flow 1200 facilitates inter-base station CLI mitigation via messaging. Aspects of the first network node 1202 and/or the second network node 1204 may be implemented by one of the base stations 102 of FIG. 1 and/or the base station 410 of FIG. 4. Aspects of the first UE 1206 and/or the second UE 1208 may be implemented by one of the UEs 104 of FIG. 1 and/or the UE 450 of FIG. 4. Although not shown in the illustrated example of FIG. 12, it may be appreciated that in additional or alternative examples, one or more of the network nodes and/or the UEs may be in communication with one or more other network entities or UEs.

As an example, the network node 1204 (e.g., which may be referred to as an interfering base station) may transmit a reference signal 1218 to enable the network node 1202 (e.g., which may be referred to as an interfered base station) to measure the corresponding interference caused by downlink transmission of the network node 1204 to the uplink reception of the network node 1202. The reference signal may include at least an SSB or a non-zero power channel state information reference signal (NZP CSI-RS). The network node 1202 may measure the interference for each of multiple downlink and uplink beam pairs, e.g. each beam pair including an uplink beam of the network node 1202 and a downlink beam of the network node 1204. For each beam pair, the network node 1202 measures interference caused to uplink reception on the uplink beam based on a downlink transmission on the downlink beam by the network node 1204. FIG. 12 shows that the network node 1202 performs CLI measurements 1220 and 1222, e.g., in order to perform measurements with multiple beam pairs. In some aspects, the beam pair measurements may include some measurement aspects described in connection with FIGS. 5A-5C. Although only a single network node is illustrated as performing the measurements, 1220 and 1222, similar measurements of the reference signal 1218 may be performed by multiple network nodes (e.g., multiple base stations) that may experience interference from the network node 1204. The network node 1202, e.g., and any other network nodes making the measurements, may then provide a report 1224 and/or 1226 based on the CLI measurements 1220 and 1222.

Based on the measurement results, the network node 1202 as the interfered base station or a central coordinator (e.g. such as the network node 1210) may signal or indicate, a preferred set of one or more downlink beams or a non-preferred set of one or more downlink for each interfering base station. For example, the network node 1202 may indicate the preferred or non-preferred beam pairs at 1228 in CLI information. In some aspects, the network node 1210, as a central coordinator, may indicate the preferred/non-preferred beams pairs to the network node 1204 at 1234. If the network node 1202 or 1210 indicates a set of non-preferred beams, the network node 1204 may refrain from using the non-preferred beams which can be associated with certain time and frequency resources. If the network node 1202 or 1210 indicates a set of preferred beams, the network node 1204 may transmit downlink communication using the indicated set of beams. In some aspects, the network node 1202 or 1210 may identify one or more additional operation parameters of the network node 1204 that would reduce or avoid interference to the network node 1202. As an example, the network node 1202 or 1210 may determine a periodic time resource and/or a frequency resource that is preferred or non-preferred for use by the network node 1204 to avoid interference to the network node 1202. If the network node 1202 or 1210 indicates a set of non-preferred time/frequency resources, the network node 1204 may refrain from using the indicated resources for downlink communication. If the network node 1202 or 1210 indicates a set of preferred time/frequency resources, the network node 1204 may transmit downlink communication using the indicated time/frequency resources. As another example, the network node 1202 or 1210 may indicate a power back off for use by the network node 1204. The network node 1204 may use the indication of the beam(s) and/or the operation parameters to help avoid causing interference to the network node 1202.

The network node 1202 can send a report 1224 and/or 1226 based on the measurements performed at 1220 and/or 1222. As illustrated, the report may be directed to the network node causing the interference or may be provided to a different network node that operates as a central coordinator to help reduce or avoid interference between base stations. The report 1224 and/or 1226 may be transmitted as an over-the-air (OTA) transmission. The report 1224 and/or 1226 may be provided over a backhaul between the network nodes, e.g. via a gNB-CU or an OAM.

The network node 1204 may use the report 1224, the CLI information 1228, and/or the information (e.g., 1234) from a central coordinator such as the network node 1210 to adjust its downlink transmissions, at 1244. The network node 1204 then transmits downlink communication 1246 such as to a UE 1208 with the adjustment. For example, the network node 1204 may avoid a non-preferred beam, non-preferred frequency resources, and/or non-preferred time period in the downlink communication 1246 based on the information received from the network node 1202 or 1210. The network node 1204 may use a preferred beam, a preferred frequency resource, and/or a preferred timing indicated in the information from the network node 1202 or 1210. The network node 1204 may use a power back off indicated by the network node 1202 or 1210, e.g., to reduce a transmission power of the downlink transmission.

In some aspects, added fairness may be achieved through a coordination between network nodes to determine or negotiate the network node to make the adjustments to reduce CLI between the two nodes. For example, in some aspects, the network node 1204 will not automatically perform the adjustment to avoid using a high CLI downlink beam or to avoid downlink transmissions on the uplink resources of the network node 1202. Instead, the network node 1202 and network node 1204 may determine which network node will make the adjustment to achieve the CLI reduction. For example, at 1236, the network node 1204 may determine whether, as an interfering base station, the network node will avoid high CLI beams or resources or continue to transmit downlink communication (e.g., such as high priority downlink communication) without making an adjustment based on the information (which may include a report or request) from the network node 1202 or 1210. In some aspects, the network node 1204 may transmit the downlink communication 1246 without an adjustment based on the determination 1236. In some aspects, the network node 1204 may determine, at 1236, a type of adjustment to make from multiple potential adjustments (e.g., including one or more of a beam adjustment, frequency adjustment, timing adjustment, or power adjustment, among other examples).

In some aspects, the network node 1202 (e.g., as a measurement base station or interfered base station) may provide CLI information including information such as a QoS class level as part of exchanging information between the network nodes. In some aspects, a rule may be defined in which a lower QoS class network node (e.g., the network node with lower QoS communication to transmit or receive between the two network nodes) will conduct a CLI reduction solution by making an adjustment to its communication. For example, the network node 1204 may avoid transmitting the downlink communication 1246 with high CLI beam (e.g., a downlink transmission beam that causes a higher amount of CLI to the network node 1202) or resources (e.g., time and/or frequency resources that lead to higher amounts of CLI to the network node 1202), or alternately, the network node 1202 may avoid scheduling uplink reception on a high CLI beam (e.g., an uplink reception beam that experiences higher CLI from the network node 1204) or resources (e.g., time and/or frequency resources that experience higher amounts of CLI from the network node 1204). For example, at 1242, the network node 1202 may adjust scheduling for its uplink communication, e.g., adjusting a beam, frequency, and or time, for the uplink communication 1248 to mitigate CLI from the network node 1204. In such aspects, the network node 1204, e.g., which may be referred to as a higher QoS class network node or the network node with the higher QoS communication, may not conduct a CLI reduction solution (e.g., as determined at 1236) and may continue to transmit the downlink communication 1246 without an adjustment and/or to receive uplink communication without an adjustment. The CLI information 1228, which may include the preferred or non-preferred beam information and/or operation information (frequency, time, and/or power back off) and QoS information. In some aspects, the network node 1202 may report or provide CLI measurement information, e.g., at 1224, CLI information with a preferred/non-preferred beam at 1228, QoS information or traffic priority information at 1230, and a mitigation parameter (e.g., which may include frequency, time, and/or power parameters) at 1232. The information, e.g., including any of 1224, 1228, 1230, and/or 1232 may be sent from the network node 1202 to the network node 1204 on F1AP between a DU and CU, in Xn signaling between CU1 and CU2, or as OTA signaling.

In some aspects, the network node 1204 may provide a response 1238 to the network node 1202 at 1238. For example, if the network node 1204 will transmit or receive communication with a higher QoS class or higher priority traffic than the QoS class indicated by the network node 1202, the network node 1204 may send a NACK or a rejection message to the network node 1202. The network node 1204 may provide a QoS class or priority information for its own traffic, at 1240.

The response 1238 and/or QoS/priority information 1240 enables the network node 1202 to be aware of the communication of the network node 1204 that would be affected by a CLI mitigation adjustment at that node. Based on the information received from the network node 1204, the network node 1204 may perform an adjustment to avoid using a beam, frequency, time, etc. for uplink communication 1248 that is impacted by the downlink communication 1246. The information, e.g., including the response 1238 and/or QoS or traffic priority information 1240 may be sent from the network node 1202 to the network node 1204 on F1AP, in Xn signaling, or as OTA signaling.

In some aspects, a network node (e.g., 1202 or 1210 as a central coordinator) may identify compatible downlink beam(s) for each interfering network node that will cause reduced interference to uplink communication of the network node 1202 on an uplink beam. In some aspects, the network nodes may exchange measurement metrics based on a network node CLI report configuration. In some aspects, the measurement metric may be an RSRP and/or RSSI. The network nodes may exchange information indicating the metrics the network node 1202 will use to measure CLI and report CLI from the network node 1204. As illustrated in FIG. 12, in some aspects, a third network node 1210 (e.g., as a central coordinator) may indicate to the network node 1202 and/or 1204 for CLI measurements to use a particular metric. In some aspects, the network node 1204 may indicate, at 1216, a metric for the network node 1202 to measure. In some aspects, the network node 1202 may information the network node 1204, e.g., at 1214, the metric that the network node 1202 will use. Then, at 1220, the network node 1202 may measure the CLI using the indicated metric, e.g., whether indicated by the network node 1202, 1204 or 1210. The indication 1212, 1214, and/or 1216 can be sent by CU, or a third-party node e.g. OAM, or a source DU to a target DU, so that network node 1202 and/or 1204 knows the metric of the CLI level that corresponds to a value that may be reported at 1224 or 1226. The indication 1212, 1214, and/or 1216 can be on F1Ap, in Xn signaling, or in OTA signaling.

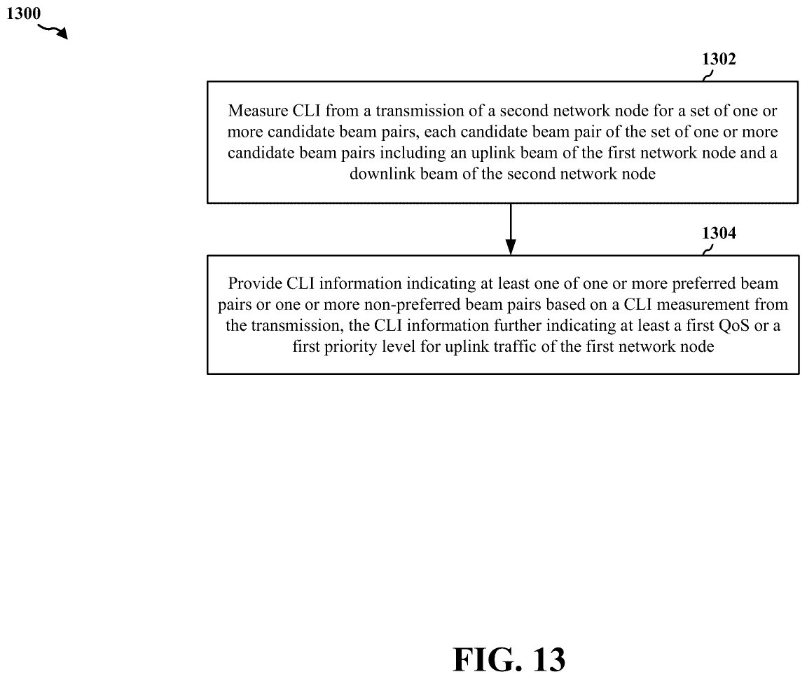

FIG. 13 is a flowchart 1300 of a method of wireless communication. The method may be performed by a network node, network entity, a base station, or one or more components of a base station (e.g., the base station 102, 410; the CU 210; the DU 212; the RU 214; the network entity 1402). The network node may be the first network node, e.g., the first network node 1202 of FIG. 12.

At 1302, the first network node measures CLI from a transmission of a second network node for a set of one or more candidate beam pairs, each candidate beam pair of the set of one or more candidate beam pairs including an uplink beam of the first network node and a downlink beam of the second network node. The measurement may be performed, e.g., by the CLI mitigation component 199. FIG. 12 illustrates an example of a network node 1202 measuring CLI based on the reference signal 1218 from the network node 1204, at 1220 and 1222.

At 1304, the first network node provides CLI information indicating at least one of one or more preferred beam pairs or one or more non-preferred beam pairs based on a CLI measurement from the transmission, the CLI information further indicating at least a first QoS or a first priority level for uplink traffic of the first network node. FIG. 12 illustrates example aspects of the network node 1202 providing CLI information, e.g., at any of 1224, 1226, 1228, 1230, and/or 1232. In some aspects, the transmission may include a reference signal from the second network node. The reference signal may include at least an SSB or an NZP CSI-RS. In some aspects, the CLI information indicates the one or more preferred beam pairs between the first network node and the second network node, the one or more preferred beam pairs having a lower CLI than other candidate beam pairs of the set of one or more candidate beam pairs. In some aspects, the CLI information further indicates at least one of: a periodic time resource based on the CLI measurement, a periodic frequency resource based on the CLI measurement, or a power reduction based on the CLI measurement. Providing the CLI information may include providing the CLI information to the second network node in over-the-air signaling or in backhaul signaling. The provision may be performed, e.g., by the CLI mitigation component 199.

In some aspects, the first network node may further receive an ACK or a NACK from the second network node in response to the CLI information and may schedule, based on reception of the NACK, the uplink traffic to avoid a first uplink beam impacted by the CLI. FIG. 12 illustrates an example of a response 1238 from the second network node. As an example, the NACK may be comprised in F1AP signaling, Xn signaling, or over-the-air signaling. In some aspects, the NACK may further indicate a second QoS or a second priority level for downlink traffic of the second network node. The reception and/or the scheduling may be performed, e.g., by the CLI mitigation component 199.

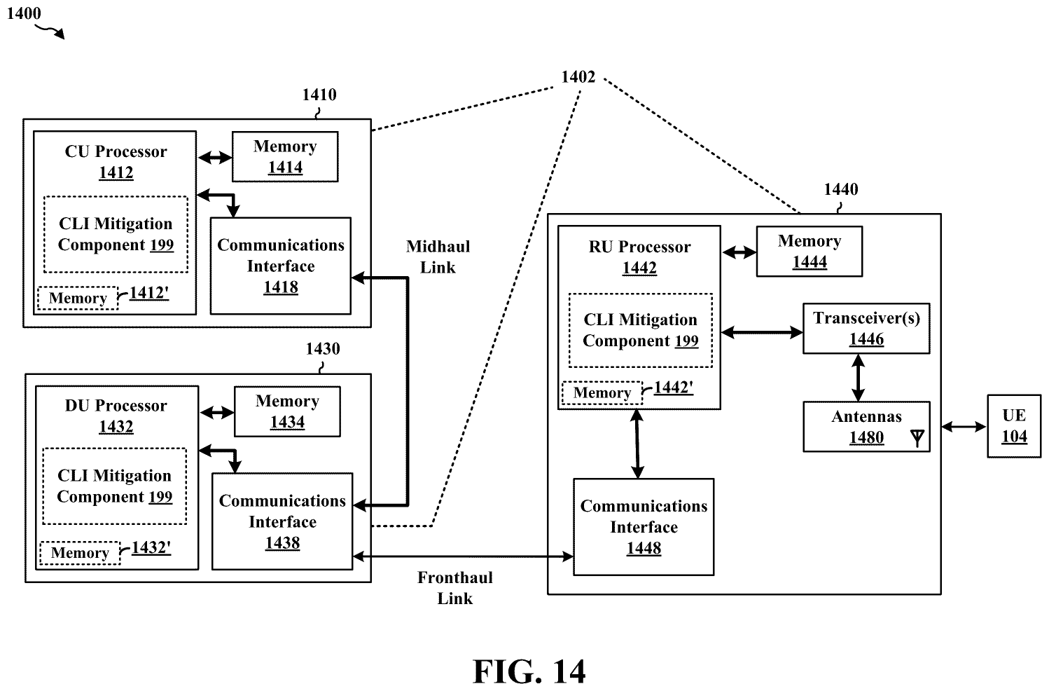

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the CLI mitigation component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor (or processor circuitry) (e.g., CU processor(s) 1412). The CU processor(s) 1412 may include at least one on-chip memory (or memory circuitry) (e.g., on-chip memory 1412′). In some aspects, may further include additional memory modules 1414 and a communications interface 1418. The CU 1410 communicates with the DU 1430 through a midhaul link, such as an F1 interface. The DU 1430 may include at least one DU processor (or processor circuitry) (e.g., DU processor(s) 1432). The DU processor(s) 1432 may include at least one on-chip memory (or memory circuitry) (e.g., on-chip memory 1432′). In some aspects, the DU 1430 may further include additional memory modules 1434 and a communications interface 1438. The DU 1430 communicates with the RU 1440 through a fronthaul link. The RU 1440 may include at least one RU processor (or processor circuitry) (e.g., RU processor(s) 1442). The RU processor(s) 1442 may include at least one on-chip memory (or memory circuitry) (e.g., on-chip memory 1442′). In some aspects, the RU 1440 may further include additional memory modules 1444, one or more transceivers 1446, antennas 1480, and a communications interface 1448. The RU 1440 communicates with the UE 104. The on-chip memories (e.g., the on-chip memory 1412′, the on-chip memory 1432′, and/or the on-chip memory 1442′) and/or the additional memory modules (e.g., the additional memory modules 1414, the additional memory modules 1434, and/or the additional memory modules 1444) may each be considered a computer-readable medium/memory. Each computer-readable medium/memory may be non-transitory. Each of the CU processor(s) 1412, the DU processor(s) 1432, the RU processor(s) 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CLI mitigation component 199 may be configured to measure CLI from a transmission of a second network node for a set of one or more candidate beam pairs, each candidate beam pair of the set of one or more candidate beam pairs including an uplink beam of the first network node and a downlink beam of the second network node; and provide CLI information indicating at least one of one or more preferred beam pairs or one or more non-preferred beam pairs based on a CLI measurement from the transmission, the CLI information further indicating at least a first QoS or a first priority level for uplink traffic of the first network node. The CLI mitigation component 199 may be further configured to receive an ACK or a NACK from the second network node in response to the CLI information; and schedule, based on reception of the NACK, the uplink traffic to avoid a first uplink beam impacted by the CLI.

The CLI mitigation component 199 may be within one or more processors of one or more of the CU 1410, DU 1430, and the RU 1440. The CLI mitigation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination.

The network entity 1402 may include a variety of components configured for various functions. For example, the CLI mitigation component 199 may include one or more hardware components that perform each of the blocks of the algorithm in the flowchart of FIG. 13.

The network entity 1402 may include a variety of components configured for various functions. In one configuration, the network entity 1402 may include means for measuring CLI from a transmission of a second network node for a set of one or more candidate beam pairs, each candidate beam pair of the set of one or more candidate beam pairs including an uplink beam of the first network node and a downlink beam of the second network node; and means for providing CLI information indicating at least one of one or more preferred beam pairs or one or more non-preferred beam pairs based on a CLI measurement from the transmission, the CLI information further indicating at least a first QoS or a first priority level for uplink traffic of the first network node. The network node may further include means for receiving an ACK or a NACK from the second network node in response to the CLI information; and means for scheduling, based on reception of the NACK, the uplink traffic to avoid a first uplink beam impacted by the CLI.

The means may be the CLI mitigation component 199 of the network entity 1402 configured to perform the functions recited by the means. As described supra, the network entity 1402 may include the TX processor 416, the RX processor 470, and the controller/processor 475. As such, in one configuration, the means may be the TX processor 416, the RX processor 470, and/or the controller/processor 475 configured to perform the functions recited by the means.

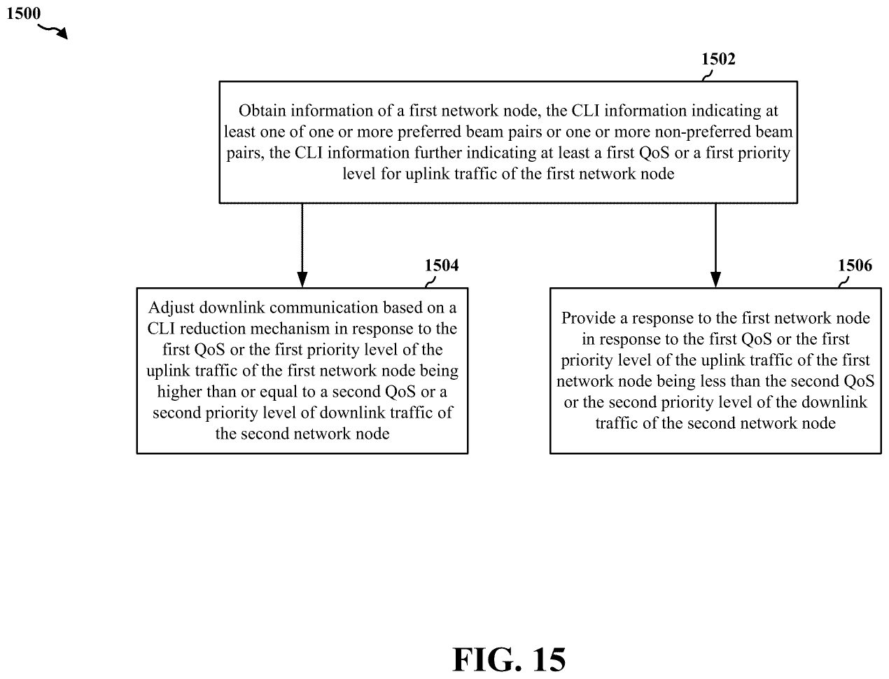

FIG. 15 is a flowchart 1500 of a method of wireless communication. The method may be performed by a network node, network entity, a base station, or one or more components of a base station (e.g., the base station 102, 410; the CU 210; the DU 212; the RU 214; the network entity 1602). The network node may be the second network node, e.g., the second network node 1204 of FIG. 12.

At 1502, the second network node obtains CLI information of a first network node, the CLI information indicating at least one of one or more preferred beam pairs or one or more non-preferred beam pairs, the CLI information further indicating at least a first QoS or a first priority level for uplink traffic of the first network node. FIG. 12 illustrates an example of a network node 1204 receiving CLI information (e.g., 1224, 1228, 1230, 1232, and/or 1234) from a network node (e.g., 1202 or 1210). In some aspects, the CLI information may indicate the one or more preferred beam pairs between the first network node and the second network node, the one or more preferred beam pairs having a lower CLI at the first network node than other candidate beam pairs in a set of one or more candidate beam pairs. The CLI information may further indicate at least one of: a periodic time resource based on a CLI measurement, a periodic frequency resource based on the CLI measurement, or a power reduction based on the CLI measurement. Obtaining the CLI information may include obtaining the CLI information in over-the-air signaling or in backhaul signaling. In some aspects, the CLI information may be based on a measurement metric corresponding to at least one of an RSRP or an RSSI. The obtaining may be performed, e.g., by the CLI mitigation component 199.

At 1504, the second network node may adjust downlink communication based on a CLI reduction mechanism in response to the first QoS or the first priority level of the uplink traffic of the first network node being higher than or equal to a second QoS or a second priority level of downlink traffic of the second network node. FIG. 12 illustrates an example of a network node 1204 adjusting downlink communication, at 1244, in response to the CLI information. As an example, with the first priority level of the uplink traffic of the first network node being higher than or equal to the second QoS or the second priority level of the downlink traffic of the second network node, and the second network node may adjust the downlink communication based on the CLI reduction mechanism to use a downlink beam from the one or more preferred beam pairs or to avoid the downlink beam from the one or more non-preferred beam pairs. The adjusting may be performed, e.g., by the CLI mitigation component 199.

At 1506, the second network node may provide a response to the first network node in response to the first QoS or the first priority level of the uplink traffic of the first network node being less than the second QoS or the second priority level of the downlink traffic of the second network node. FIG. 12 illustrates an example of a network node 1204 providing a response 1238. For example, with the first priority level of the uplink traffic of the first network node being higher than or equal to the second QoS or the second priority level of the downlink traffic of the second network node, and the second network node may provide an ACK from the second network node in response to the CLI information. With the first priority level of the uplink traffic of the first network node being less than the second QoS or the second priority level of the downlink traffic of the second network node, the second network node may provide a NACK from the second network node in response to the CLI information. In some aspects, the NACK may be comprised in F1AP signaling, Xn signaling, or over-the-air signaling. The NACK may further indicate the second QoS or the second priority level for the downlink traffic of the second network node. The providing may be performed, e.g., by the CLI mitigation component 199.

In some aspects, the second network node may further output the downlink communication on a downlink beam from the one or more non-preferred beam pairs. The output may be performed, e.g., by the CLI mitigation component 199.

In some aspects, the second network node may further output a reference signal on one or more downlink beams, and the CLI information being based on the reference signal. The reference signal may include at least an SSB or an NZP CSI-RS. The output may be performed, e.g., by the CLI mitigation component 199. FIG. 12 illustrates an example of the network node 1204 transmitting a reference signal 1218.

In some aspects, the second network node may provide an indication of a measurement metric for a CLI measurement between the first network node and the second network node, and the CLI information being based on the measurement metric. The measurement metric may correspond to at least one of an RSRP or an RSSI. The providing may be performed, e.g., by the CLI mitigation component 199. FIG. 12 illustrates an example of the network node 1204 providing metric information, e.g., at 1216.

In some aspects, the second network node may obtain an indication of a measurement metric for a CLI measurement between the first network node and the second network node, the CLI information being based on the measurement metric, and the measurement metric corresponding to at least one of an RSRP or an RSSI. The obtaining may be performed, e.g., by the CLI mitigation component 199. FIG. 12 illustrates an example of the network node 1204 receiving metric information, e.g., at 1214.

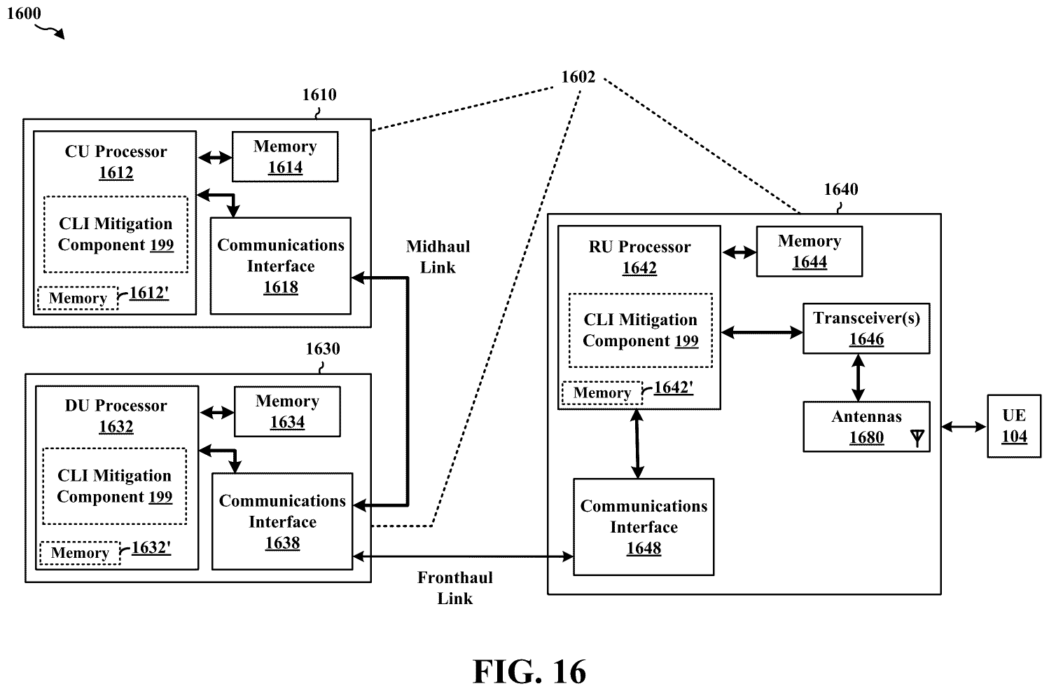

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the CLI mitigation component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processor circuitry) (e.g., CU processor(s) 1612). The CU processor(s) 1612 may include at least one on-chip memory (or memory circuitry) (e.g., on-chip memory 1612′). In some aspects, may further include additional memory modules 1614 and a communications interface 1618. The CU 1610 communicates with the DU 1630 through a midhaul link, such as an F1 interface. The DU 1630 may include at least one DU processor (or processor circuitry) (e.g., DU processor(s) 1632). The DU processor(s) 1632 may include at least one on-chip memory (or memory circuitry) (e.g., on-chip memory 1632′). In some aspects, the DU 1630 may further include additional memory modules 1634 and a communications interface 1638. The DU 1630 communicates with the RU 1640 through a fronthaul link. The RU 1640 may include at least one RU processor (or processor circuitry) (e.g., RU processor(s) 1642). The RU processor(s) 1642 may include at least one on-chip memory (or memory circuitry) (e.g., on-chip memory 1642′). In some aspects, the RU 1640 may further include additional memory modules 1644, one or more transceivers 1646, antennas 1680, and a communications interface 1648. The RU 1640 communicates with the UE 104. The on-chip memories (e.g., the on-chip memory 1612′, the on-chip memory 1632′, and/or the on-chip memory 1642′) and/or the additional memory modules (e.g., the additional memory modules 1614, the additional memory modules 1634, and/or the additional memory modules 1644) may each be considered a computer-readable medium/memory. Each computer-readable medium/memory may be non-transitory. Each of the CU processor(s) 1612, the DU processor(s) 1632, the RU processor(s) 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to obtain CLI information of a first network node, the CLI information indicating at least one of one or more preferred beam pairs or one or more non-preferred beam pairs, the CLI information further indicating at least a first QoS or a first priority level for uplink traffic of the first network node; and adjust downlink communication based on a CLI reduction mechanism in response to the first QoS or the first priority level of the uplink traffic of the first network node being higher than or equal to a second QoS or a second priority level of downlink traffic of the second network node, or provide a response to the first network node in response to the first QoS or the first priority level of the uplink traffic of the first network node being less than the second QoS or the second priority level of the downlink traffic of the second network node. The component 199 may be further configured to output the downlink communication on a downlink beam from the one or more non-preferred beam pairs. The component 199 may be further configured to output a reference signal on one or more downlink beams, and the CLI information being based on the reference signal. The component 199 may be further configured to provide an indication of a measurement metric for a CLI measurement between the first network node and the second network node, and the CLI information being based on the measurement metric. The component 199 may be further configured to obtain an indication of a measurement metric for a CLI measurement between the first network node and the second network node, the CLI information being based on the measurement metric, and the measurement metric corresponding to at least one of an RSRP or an RSSI.

The CLI mitigation component 199 may be within one or more processors of one or more of the CU 1610, DU 1630, and the RU 1640. The CLI mitigation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination.

The network entity 1602 may include a variety of components configured for various functions. For example, the CLI mitigation component 199 may include one or more hardware components that perform each of the blocks of the algorithm in the flowchart of FIG. 15.

The network entity 1602 may include a variety of components configured for various functions. In one configuration, the network entity 1602 may include means for obtaining CLI information of a first network node, the CLI information indicating at least one of one or more preferred beam pairs or one or more non-preferred beam pairs, the CLI information further indicating at least a first QoS or a first priority level for uplink traffic of the first network node; and means for adjusting downlink communication based on a CLI reduction mechanism in response to the first QoS or the first priority level of the uplink traffic of the first network node being higher than or equal to a second QoS or a second priority level of downlink traffic of the second network node, or means for providing a response to the first network node in response to the first QoS or the first priority level of the uplink traffic of the first network node being less than the second QoS or the second priority level of the downlink traffic of the second network node. The network entity may further include means for outputting the downlink communication on a downlink beam from the one or more non-preferred beam pairs. The network entity may further include means for outputting a reference signal on one or more downlink beams, and the CLI information being based on the reference signal. The network entity may further include means for providing an indication of a measurement metric for a CLI measurement between the first network node and the second network node, and the CLI information being based on the measurement metric. The network entity may further include means for obtaining an indication of a measurement metric for a CLI measurement between the first network node and the second network node, the CLI information being based on the measurement metric, and the measurement metric corresponding to at least one of an RSRP or an RSSI.

The means may be the CLI mitigation component 199 of the network entity 1602 configured to perform the functions recited by the means. As described supra, the network entity 1602 may include the TX processor 416, the RX processor 470, and the controller/processor 475. As such, in one configuration, the means may be the TX processor 416, the RX processor 470, and/or the controller/processor 475 configured to perform the functions recited by the means.

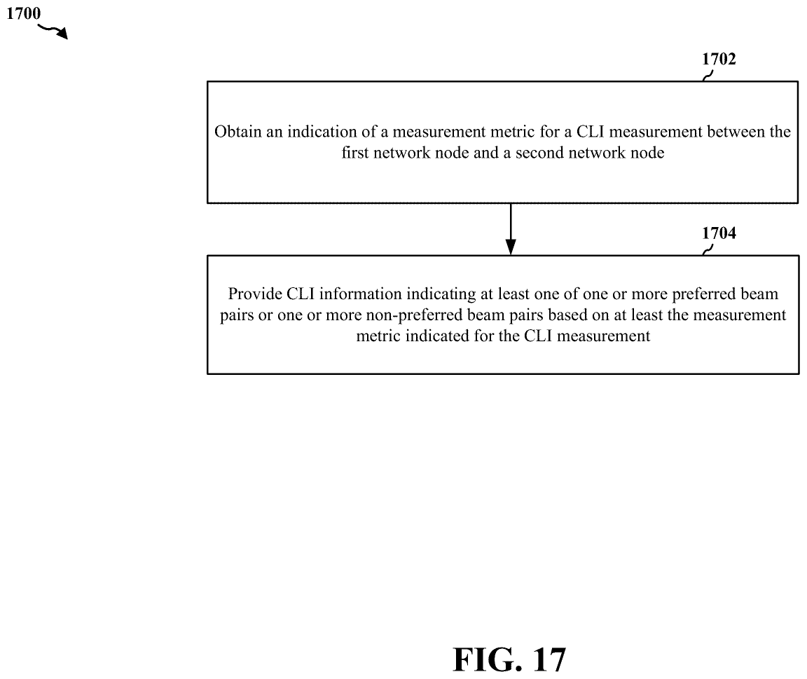

FIG. 17 is a flowchart 1700 of a method of wireless communication. The method may be performed by a network node, network entity, a base station, or one or more components of a base station (e.g., the base station 102, 410; the CU 210; the DU 212; the RU 214; the network entity 1802). The network node may be the first network node, e.g., the first network node 1202 of FIG. 12.

At 1702, the first network node obtains an indication of a measurement metric for a CLI measurement between the first network node and a second network node. The measurement metric may correspond to at least one of an RSRP or an RSSI. The indication may be from the second network node, a CU, a third party, a source DU, or a target DU. The obtaining may be performed, e.g., by the CLI mitigation component 199. FIG. 12 illustrates an example of the network node 1202 receiving metric information, at 1212.

At 1704, the first network node provides CLI information indicating at least one of one or more preferred beam pairs or one or more non-preferred beam pairs based on at least the measurement metric indicated for the CLI measurement. Providing the CLI measurement may include providing the CLI measurement in F1AP signaling, Xn signaling, or over-the-air signaling. The providing may be performed, e.g., by the CLI mitigation component 199. FIG. 12 illustrates an example of the network node 1202 providing the CLI information, e.g., at 1224, 1226, 1228, 1230, and/or 1232.

In some aspects, the first network node may further measure the CLI measurement from a reference signal obtained from the second network node for each candidate beam pair of a set of one or more candidate beam pairs, each candidate beam pair of the set of one or more candidate beam pairs including an uplink beam of the first network node and a downlink beam of the second network node, and the reference signal includes at least an SSB or an NZP CSI-RS. The measurement may be performed, e.g., by the CLI mitigation component 199. FIG. 12 illustrates an example of the network node 1202 measuring the CLI, at 1220 and 1222.

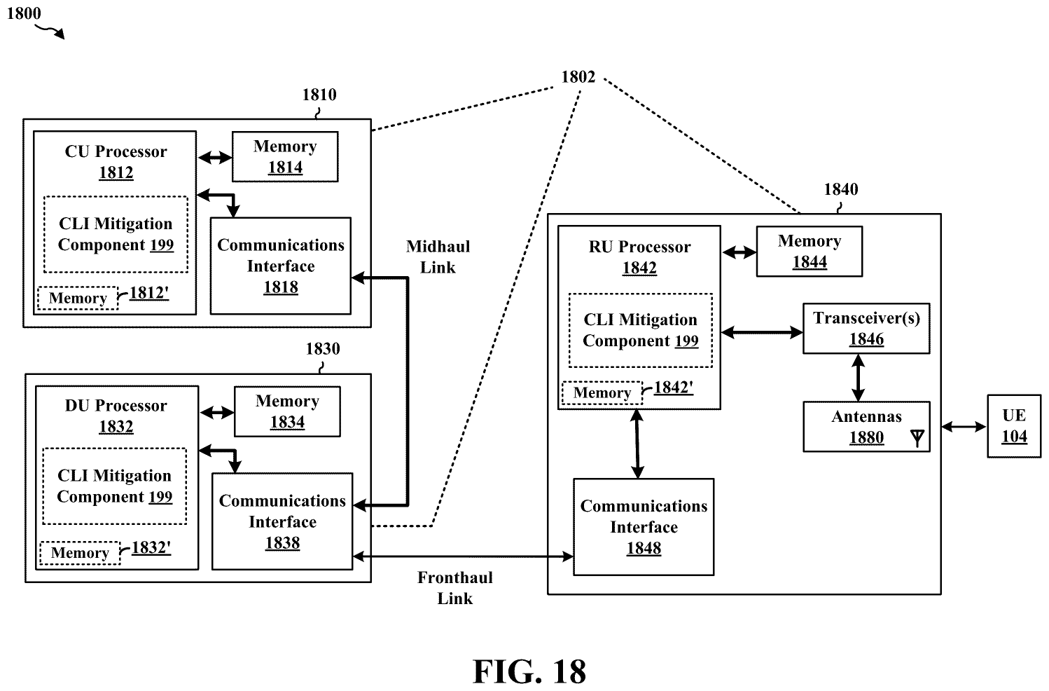

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the CLI mitigation component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include at least one CU processor (or processor circuitry) (e.g., CU processor(s) 1812). The CU processor(s) 1812 (or processor circuitry) may include at least one on-chip memory (or memory circuitry) (e.g., on-chip memory 1812′). In some aspects, may further include additional memory modules 1814 and a communications interface 1818. The CU 1810 communicates with the DU 1830 through a midhaul link, such as an F1 interface. The DU 1830 may include at least one DU processor (or processor circuitry) (e.g., DU processor(s) 1832). The DU processor(s) 1832 may include at least one on-chip memory (or memory circuitry) (e.g., on-chip memory 1832′). In some aspects, the DU 1830 may further include additional memory modules 1834 and a communications interface 1838. The DU 1830 communicates with the RU 1840 through a fronthaul link. The RU 1840 may include at least one RU processor (or processor circuitry) (e.g., RU processor(s) 1842). The RU processor(s) 1842 may include at least one on-chip memory (or memory circuitry) (e.g., on-chip memory 1842′). In some aspects, the RU 1840 may further include additional memory modules 1844, one or more transceivers 1846, antennas 1880, and a communications interface 1848. The RU 1840 communicates with the UE 104. The on-chip memories (e.g., the on-chip memory 1812′, the on-chip memory 1832′, and/or the on-chip memory 1842′) and/or the additional memory modules (e.g., the additional memory modules 1814, the additional memory modules 1834, and/or the additional memory modules 1844) may each be considered a computer-readable medium/memory. Each computer—As discussed supra, the component 199 may be configured to obtain an indication of a measurement metric for a CLI measurement between the first network node and a second network node; and provide CLI information indicating at least one of one or more preferred beam pairs or one or more non-preferred beam pairs based on at least the measurement metric indicated for the CLI measurement. The component 199 may be further configured to measure the CLI measurement from a reference signal obtained from the second network node for each candidate beam pair of a set of one or more candidate beam pairs, each candidate beam pair of the set of one or more candidate beam pairs including an uplink beam of the first network node and a downlink beam of the second network node, and the reference signal includes at least an SSB or an NZP CSI-RS.

The CLI mitigation component 199 may be within one or more processors of one or more of the CU 1810, DU 1830, and the RU 1840. The CLI mitigation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination.

The network entity 1802 may include a variety of components configured for various functions. For example, the CLI mitigation component 199 may include one or more hardware components that perform each of the blocks of the algorithm in the flowchart of FIG. 17.

The network entity 1802 may include a variety of components configured for various functions. In one configuration, the network entity 1802 may include means for obtaining an indication of a measurement metric for a CLI measurement between the first network node and a second network node; and means for providing CLI information indicating at least one of one or more preferred beam pairs or one or more non-preferred beam pairs based on at least the measurement metric indicated for the CLI measurement. The network entity may further include means for measuring the CLI measurement from a reference signal obtained from the second network node for each candidate beam pair of a set of one or more candidate beam pairs, each candidate beam pair of the set of one or more candidate beam pairs including an uplink beam of the first network node and a downlink beam of the second network node, and the reference signal includes at least an SSB or an NZP CSI-RS.

The means may be the CLI mitigation component 199 of the network entity 1802 configured to perform the functions recited by the means. As described supra, the network entity 1802 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” or “provide” data or other information, such as a transmission, signal, or message, may transmit the data or other information, for example with a transceiver, or may send the data to a device that transmits the data. A device configured to “obtain” data or other information, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network node, comprising: measuring CLI from a transmission of a second network node for a set of one or more candidate beam pairs, each candidate beam pair of the set of one or more candidate beam pairs including an uplink beam of the first network node and a downlink beam of the second network node; and providing CLI information indicating at least one of one or more preferred beam pairs or one or more non-preferred beam pairs based on a CLI measurement from the transmission, the CLI information further indicating at least a first QoS or a first priority level for uplink traffic of the first network node.

In aspect 2, the method of aspect 1 further includes that the transmission includes a reference signal from the second network node.

In aspect 3, the method of aspect 2 further includes that the reference signal includes at least a SSB or a NZP CSI-RS.

In aspect 4, the method of any of aspects 1-3 further includes that the CLI information indicates the one or more preferred beam pairs between the first network node and the second network node, the one or more preferred beam pairs having a lower CLI than other candidate beam pairs of the set of one or more candidate beam pairs.

In aspect 5, the method of any of aspects 1-4 further includes that the CLI information further indicates at least one of: a periodic time resource based on the CLI measurement, a periodic frequency resource based on the CLI measurement, or a power reduction based on the CLI measurement.

In aspect 6, the method of any of aspects 1-5 further includes that the first network node provides the CLI information to the second network node in over-the-air signaling or in backhaul signaling.

In aspect 7, the method of any of aspects 1-6 further includes receiving an ACK or a NACK from the second network node in response to the CLI information, and scheduling, based on reception of the NACK, the uplink traffic to avoid a first uplink beam impacted by the CLI.

In aspect 8, the method of aspect 7 further includes that the NACK is comprised in F1AP signaling, Xn signaling, or over-the-air signaling.

In aspect 9, the method of aspect 7 further includes that the NACK further indicates a second QoS or a second priority level for downlink traffic of the second network node.

Aspect 10 is an apparatus for wireless communication at a network node, comprising: one or more memories; and one or more processors coupled to the one or more memories and, based at least in part on information stored in the one or more memories, the one or more processors that, individually or in any combination, are operable to cause the network node to perform the method of any of aspects 1-9.

Aspect 11 is an apparatus for wireless communication at a network node, comprising: one or more memories; and one or more processors coupled to the one or more memories and, based at least in part on information stored in the one or more memories, the one or more processors that, individually or in any combination, are configured to cause the network node to perform the method of any of aspects 1-9.

Aspect 12 is an apparatus for wireless communication at a network node, comprising: one or more memories; and one or more processors coupled to the one or more memories and, the one or more processors, individually or in any combination, are configured to cause the network node to perform the method of any of aspects 1-9.

Aspect 13 is an apparatus for wireless communication at a network node, comprising: a processing system that includes processor circuitry and memory circuitry that stores code and is coupled with the processor circuitry, the processing system configured to cause the network node to perform the method of one or more of aspects 1-9.

Aspect 14 is an apparatus for wireless communication at a network node, comprising means for performing the method of any of aspects 1-9.

In aspect 15, the apparatus of any of aspects 10-14 further includes one or more antennas or one or more transceivers.

Aspect 16 is a computer-readable storage medium (e.g., a non-transitory computer-readable storage medium), storing computer executable code at a first network node, the code when executed by one or more processors causes the first network node to perform the method of one or more of aspects 1-9.

Aspect 17 is a method of wireless communication at a second network node, comprising: obtaining CLI information of a first network node, the CLI information indicating at least one of one or more preferred beam pairs or one or more non-preferred beam pairs, the CLI information further indicating at least a first QoS or a first priority level for uplink traffic of the first network node; and adjusting downlink communication based on a CLI reduction mechanism in response to the first QoS or the first priority level of the uplink traffic of the first network node being higher than or equal to a second QoS or a second priority level of downlink traffic of the second network node, or providing a response to the first network node in response to the first QoS or the first priority level of the uplink traffic of the first network node being less than the second QoS or the second priority level of the downlink traffic of the second network node.

In aspect 18, the method of aspect 17 further includes that the first priority level of the uplink traffic of the first network node being higher than or equal to the second QoS or the second priority level of the downlink traffic of the second network node, and the method includes adjusting the downlink communication based on the CLI reduction mechanism to use a downlink beam from the one or more preferred beam pairs or to avoid the downlink beam from the one or more non-preferred beam pairs.

In aspect 19, the method of aspect 17 further includes that the first priority level of the uplink traffic of the first network node being higher than or equal to the second QoS or the second priority level of the downlink traffic of the second network node, and the method includes providing an ACK from the second network node in response to the CLI information.

In aspect 20, the method of aspect 17 further includes that the first priority level of the uplink traffic of the first network node being less than the second QoS or the second priority level of the downlink traffic of the second network node, and the method includes providing a NACK from the second network node in response to the CLI information.

In aspect 21, the method of aspect 20 further includes outputting the downlink communication on a downlink beam from the one or more non-preferred beam pairs.

In aspect 22, the method of aspect 20 or 21 further includes that the NACK is comprised in F1AP signaling, Xn signaling, or over-the-air signaling.

In aspect 23, the method of any of aspects 20-22 further includes that the NACK further indicates the second QoS or the second priority level for the downlink traffic of the second network node.

In aspect 24, the method of any of aspects 17-23 further includes outputting a reference signal on one or more downlink beams, and the CLI information being based on the reference signal.

In aspect 25, the method of aspect 24 further includes that the reference signal includes at least a SSB or an NZP CSI-RS.

In aspect 26, the method of any of aspects 17-25 further includes that the CLI information indicates the one or more preferred beam pairs between the first network node and the second network node, the one or more preferred beam pairs having a lower CLI at the first network node than other candidate beam pairs in a set of one or more candidate beam pairs.

In aspect 27, the method of any of aspects 17-26 further includes that the CLI information further indicates at least one of: a periodic time resource based on a CLI measurement, a periodic frequency resource based on the CLI measurement, or a power reduction based on the CLI measurement.

In aspect 28, the method of any of aspects 17-27, wherein obtain the CLI information is obtained in over-the-air signaling or in backhaul signaling.

In aspect 29, the method of any of aspects 17-28 further includes providing an indication of a measurement metric for a CLI measurement between the first network node and the second network node, and the CLI information being based on the measurement metric.

In aspect 30, the method of aspect 29 further includes that the measurement metric corresponds to at least one of an RSRP or an RSSI.

In aspect 31, the method of any of aspects 17-30 further includes the CLI information is based on a measurement metric corresponding to at least one of an RSRP or an RSSI.

In aspect 32, the method of any of aspects 17-31 further includes obtaining an indication of a measurement metric for a CLI measurement between the first network node and the second network node, the CLI information being based on the measurement metric, and the measurement metric corresponding to at least one of an RSRP or an RSSI.

Aspect 33 is an apparatus for wireless communication at a second network node, comprising: one or more memories; and one or more processors coupled to the one or more memories and, based at least in part on information stored in the one or more memories, the one or more processors that, individually or in any combination, are operable to cause the second network node to perform the method of any of aspects 17-32.

Aspect 34 is an apparatus for wireless communication at a second network node, comprising: one or more memories; and one or more processors coupled to the one or more memories and, based at least in part on information stored in the one or more memories, the one or more processors that, individually or in any combination, are configured to cause the second network node to perform the method of any of aspects 17-32.

Aspect 35 is an apparatus for wireless communication at a second network node, comprising: one or more memories; and one or more processors coupled to the one or more memories and, the one or more processors, individually or in any combination, are configured to cause the second network node to perform the method of any of aspects 17-32.

Aspect 36 is an apparatus for wireless communication at a second network node, comprising: a processing system that includes processor circuitry and memory circuitry that stores code and is coupled with the processor circuitry, the processing system configured to cause the second network node to perform the method of one or more of aspects 17-32.

Aspect 37 is an apparatus for wireless communication at a second network node, comprising means for performing the method of any of aspects 17-32.

In aspect 38, the apparatus of any of aspects 33-37 further includes one or more antennas or one or more transceivers.

Aspect 39 is a computer-readable storage medium (e.g., a non-transitory computer-readable storage medium), storing computer executable code at a second network node, the code when executed by one or more processors causes the second network node to perform the method of one or more of aspects 17-32.

Aspect 40 is a method of wireless communication at a first network node, comprising: obtaining an indication of a measurement metric for a CLI measurement between the first network node and a second network node; and providing CLI information indicating at least one of one or more preferred beam pairs or one or more non-preferred beam pairs based on at least the measurement metric indicated for the CLI measurement.

In aspect 41, the method of aspect 40 further includes that the measurement metric corresponds to at least one of an RSRP or an RSSI.

In aspect 42, the method of aspect 40 or 41 further includes that the indication is from the second network node, a CU, a third party, a source DU, or a target DU.

In aspect 43, the method of aspect 40-42 further includes that the first network node provides the CLI measurement in F1AP signaling, Xn signaling, or over-the-air signaling.

In aspect 44, the method of any of aspects 40-43 further includes measuring the CLI measurement from a reference signal obtained from the second network node for each candidate beam pair of a set of one or more candidate beam pairs, each candidate beam pair of the set of one or more candidate beam pairs including an uplink beam of the first network node and a downlink beam of the second network node, and the reference signal includes at least an SSB or an NZP CSI-RS.

Aspect 45 is an apparatus for wireless communication at a first network node, comprising: one or more memories; and one or more processors coupled to the one or more memories and, based at least in part on information stored in the one or more memories, the one or more processors that, individually or in any combination, are operable to cause the first network node to perform the method of any of aspects 40-44.

Aspect 46 is an apparatus for wireless communication at a first network node, comprising: one or more memories; and one or more processors coupled to the one or more memories and, based at least in part on information stored in the one or more memories, the one or more processors that, individually or in any combination, are configured to cause the first network node to perform the method of any of aspects 40-44.

Aspect 47 is an apparatus for wireless communication at a first network node, comprising: one or more memories; and one or more processors coupled to the one or more memories and, the one or more processors, individually or in any combination, are configured to cause the first network node to perform the method of any of aspects 40-44.

Aspect 48 is an apparatus for wireless communication at a first network node, comprising: a processing system that includes processor circuitry and memory circuitry that stores code and is coupled with the processor circuitry, the processing system configured to cause the first network node to perform the method of one or more of aspects 40-44.

Aspect 49 is an apparatus for wireless communication at a first network node, comprising means for performing the method of any of aspects 40-44.

In aspect 50, the apparatus of any of aspects 40-49 further includes one or more antennas or one or more transceivers.

Aspect 51 is a computer-readable storage medium (e.g., a non-transitory computer-readable storage medium), storing computer executable code at a first network node, the code when executed by one or more processors causes the first network node to perform the method of one or more of aspects 40-44.

What is claimed is:

1. An apparatus for wireless communication at a first network node, comprising:
one or more memories; and
one or more processors coupled to the one or more memories and, based at least in part on information stored in the one or more memories, the one or more processors that, individually or in any combination, are operable to cause the first network node to:
measure cross link interference (CLI) from a transmission of a second network node for a set of one or more candidate beam pairs, each candidate beam pair of the set of one or more candidate beam pairs including an uplink beam of the first network node and a downlink beam of the second network node; and
provide CLI information indicating at least one of one or more preferred beam pairs or one or more non-preferred beam pairs based on a CLI measurement from the transmission, the CLI information further indicating at least a first Quality of Service (QoS) or a first priority level for uplink traffic of the first network node.

2. The apparatus of claim 1, further comprising one or more antennas coupled to the one or more processors, wherein the transmission includes a reference signal from the second network node.

3. The apparatus of claim 2, wherein the reference signal includes at least a synchronization signal block (SSB) or a non-zero power channel state information reference signal (NZP CSI-RS).

4. The apparatus of claim 1, wherein the CLI information indicates the one or more preferred beam pairs between the first network node and the second network node, the one or more preferred beam pairs having a lower CLI than other candidate beam pairs of the set of one or more candidate beam pairs.

5. The apparatus of claim 1, wherein the CLI information further indicates at least one of:
a periodic time resource based on the CLI measurement,
a periodic frequency resource based on the CLI measurement, or
a power reduction based on the CLI measurement.

6. The apparatus of claim 1, wherein to provide the CLI information, the one or more processors are configured to cause the first network node to provide the CLI information to the second network node in over-the-air signaling or in backhaul signaling.

7. The apparatus of claim 1, wherein the one or more processors are further configured to cause the first network node to:
receive an acknowledgement (ACK) or a negative acknowledgement (NACK) from the second network node in response to the CLI information; and
schedule, based on reception of the NACK, the uplink traffic to avoid a first uplink beam impacted by the CLI.

8. The apparatus of claim 7, wherein the NACK is comprised in F1AP signaling, Xn signaling, or over-the-air signaling.

9. The apparatus of claim 7, wherein the NACK further indicates a second QoS or a second priority level for downlink traffic of the second network node.

10. An apparatus for wireless communication at a second network node, comprising:
one or more memories; and
one or more processors coupled to the one or more memories and, based at least in part on information stored in the one or more memories, the one or more processors that, individually or in any combination, are operable to cause the second network node to:
obtain cross link interference (CLI) information of a first network node, the CLI information indicating at least one of one or more preferred beam pairs or one or more non-preferred beam pairs, the CLI information further indicating at least a first Quality of Service (QoS) or a first priority level for uplink traffic of the first network node; and
adjust downlink communication based on a CLI reduction mechanism in response to the first QoS or the first priority level of the uplink traffic of the first network node being higher than or equal to a second QoS or a second priority level of downlink traffic of the second network node, or
provide a response to the first network node in response to the first QoS or the first priority level of the uplink traffic of the first network node being less than the second QoS or the second priority level of the downlink traffic of the second network node.

11. The apparatus of claim 10, wherein the first priority level of the uplink traffic of the first network node being higher than or equal to the second QoS or the second priority level of the downlink traffic of the second network node, and the one or more processors are configured to cause the first network node to adjust the downlink communication based on the CLI reduction mechanism to use a downlink beam from the one or more preferred beam pairs or to avoid the downlink beam from the one or more non-preferred beam pairs.

12. The apparatus of claim 10, wherein the first priority level of the uplink traffic of the first network node being higher than or equal to the second QoS or the second priority level of the downlink traffic of the second network node, and the one or more processors are configured to cause the first network node to provide an acknowledgement (ACK) from the second network node in response to the CLI information.

13. The apparatus of claim 10, wherein the first priority level of the uplink traffic of the first network node being less than the second QoS or the second priority level of the downlink traffic of the second network node, and the one or more processors are configured to cause the first network node to provide a negative acknowledgement (NACK) from the second network node in response to the CLI information.

14. The apparatus of claim 13, wherein the one or more processors are further configured to cause the second network node to:
output the downlink communication on a downlink beam from the one or more non-preferred beam pairs.

15. The apparatus of claim 13, wherein the NACK is comprised in F1AP signaling, Xn signaling, or over-the-air signaling.

16. The apparatus of claim 13, wherein the NACK further indicates the second QoS or the second priority level for the downlink traffic of the second network node.

17. The apparatus of claim 10, further comprising one or more antennas coupled to the one or more processors, wherein the one or more processors are further configured to cause the second network node to:
output a reference signal on one or more downlink beams, and the CLI information being based on the reference signal.

18. The apparatus of claim 17, wherein the reference signal includes at least a synchronization signal block (SSB) or a non-zero power channel state information reference signal (NZP CSI-RS).

19. The apparatus of claim 10, wherein the CLI information indicates the one or more preferred beam pairs between the first network node and the second network node, the one or more preferred beam pairs having a lower CLI at the first network node than other candidate beam pairs in a set of one or more candidate beam pairs.

20. The apparatus of claim 10, wherein the CLI information further indicates at least one of:
a periodic time resource based on a CLI measurement,
a periodic frequency resource based on the CLI measurement, or
a power reduction based on the CLI measurement.

21. The apparatus of claim 10, wherein to obtain the CLI information, the one or more processors are configured to cause the second network node to obtain the CLI information in over-the-air signaling or in backhaul signaling.

22. The apparatus of claim 10, wherein the one or more processors are further configured to cause the second network node to:
provide an indication of a measurement metric for a CLI measurement between the first network node and the second network node, and the CLI information being based on the measurement metric.

23. The apparatus of claim 22, wherein the measurement metric corresponds to at least one of a reference signal received power (RSRP) or a reference signal strength indicator (RSSI).

24. The apparatus of claim 10, wherein the CLI information is based on a measurement metric corresponding to at least one of a reference signal received power (RSRP) or a reference signal strength indicator (RSSI).

25. The apparatus of claim 10, wherein the one or more processors are further configured to cause the second network node to:
obtain an indication of a measurement metric for a CLI measurement between the first network node and the second network node, the CLI information being based on the measurement metric, and the measurement metric corresponding to at least one of a reference signal received power (RSRP) or a reference signal strength indicator (RSSI).

26. An apparatus for wireless communication at a first network node, comprising:
one or more memories; and
one or more processors coupled to the one or more memories and, based at least in part on information stored in the one or more memories, the one or more processors that, individually or in any combination, are operable to cause the first network node to:
obtain an indication of a measurement metric for a cross link interference (CLI) measurement between the first network node and a second network node; and
provide CLI information indicating at least one of one or more preferred beam pairs or one or more non-preferred beam pairs based on at least the measurement metric indicated for the CLI measurement.

27. The apparatus of claim 26, further comprising one or more antennas coupled to the one or more processors, wherein the measurement metric corresponds to at least one of a reference signal received power (RSRP) or a reference signal strength indicator (RSSI).

28. The apparatus of claim 26, wherein the indication is from the second network node, a central unit (CU), a third party, a source distributed unit (DU), or a target DU.

29. The apparatus of claim 26, wherein to provide the CLI measurement, the one or more processors are configured to cause the first network node to provide the CLI measurement in F1AP signaling, Xn signaling, or over-the-air signaling.

30. The apparatus of claim 26, wherein the one or more processors are further configured to cause the first network node to:
measure the CLI measurement from a reference signal obtained from the second network node for each candidate beam pair of a set of one or more candidate beam pairs, each candidate beam pair of the set of one or more candidate beam pairs including an uplink beam of the first network node and a downlink beam of the second network node, and the reference signal includes at least a synchronization signal block (SSB) or a non-zero power channel state information reference signal (NZP CSI-RS).
